(19) United States
(12) Patent Application Publication
(10) Pub. No.: US 2024/0352188 A1
(43) Pub. Date: Oct. 24, 2024

(54) Method for Preparing a Polysiloxane-Polycarbonate Block Copolymer

(71) Applicant: Kovestro Deutschland AG, Leverkusen (DE)

(72) Inventors: Ulrich Liesenfelder, Bergisch Gladbach (DE); Johan Vanden Eynde, Zwijnaarde (BE); Marc Buts, Duffel (BE); Alexander Meyer, Düsseldorf (DE); Paul Van Dorst, Merksplas (BE); Max Spapens, Bergen op Zoom (NL); Marcus De Wolf, Deurne (Antwerpen) (BE); Roland Engberg, Düsseldorf (DE); Gregor Karrenberg, Wuppertal (DE)

(21) Appl. No.: 18/292,485

(22) PCT Filed: Jul. 19, 2022
(86) PCT No.: PCT/EP2022/070228

§ 371 Date: Jan. 26, 2024

(30) Foreign Application Priority Data
Jul. 27, 2021 (EP) 21187927.5

(51) Int. Cl. C08G 64/18; C08G 64/20; C08G 77/00; C08G 77/16; C08G 77/448

(52) U.S. Cl. CPC C08G 64/186; C08G 64/205; C08G 77/16; C08G 77/448; C08G 77/80

(57) ABSTRACT

A continuous process for producing a polysiloxane-polycarbonate block copolymer by polycondensation, comprising use of at least one thin-film evaporator, where this at least one thin-film evaporator includes at the circumference at least two wiper blade elements which rotate in the at least one thin-film evaporator. An oligocarbonate is reacted with a hydroxyaryl-terminated polysiloxane to afford a polysiloxane-polycarbonate block copolymer. In the reaction of the oligocarbonate with the hydroxyaryl-terminated polysiloxane using at least one thin-film evaporator, certain process parameters are observed. The polysiloxane-polycarbonate block copolymer produced has a small volume fraction of large polysiloxane domains at simultaneously narrow size distribution of the polysiloxane domains and exhibits good mechanical properties, in particular tough fracture behaviour, good processability, and good flowability.

### CROSS-REFERENCE TO RELATED APPLICATIONS

This application is the United States national phase of International Application No. PCT/EP2022/070228 filed Jul. 19, 2022, and claims priority to European Patent Application No. 21187927.5 filed Jul. 27, 2021, the disclosures of which are hereby incorporated by reference in their entireties.

### BACKGROUND

### Technical Field

The present invention relates to a continuous process for producing a polysiloxane-polycarbonate block copolymer by polycondensation, wherein this process is characterized by the use of at least one thin-film evaporator, wherein this at least one thin-film evaporator comprises at the circumference at least two wiper blade elements which rotate in the at least one thin-film evaporator. In the process according to the invention, an oligocarbonate is reacted with a hydroxyaryl-terminated polysiloxane to afford a polysiloxane-polycarbonate block copolymer—also known as SiCoPC. The process is further characterized in that, in the reaction of the oligocarbonate with the hydroxyaryl-terminated polysiloxane using at least one thin-film evaporator, certain process parameters are observed. The polysiloxane-polycarbonate block copolymer produced by the process according to the invention has a small volume fraction of large polysiloxane domains at simultaneously narrow size distribution of the polysiloxane domains and is characterized by good mechanical properties, in particular tough fracture behaviour in the notched impact test according to ISO 7391/ISO 180A, good processability, for example in injection moulding or in extrusion, and good flowability.

In the context of the present invention, a small volume fraction of large polysiloxane domains at simultaneously narrow size distribution of the polysiloxane domains is achieved when, in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%. Such a volume fraction of large polysiloxane domains at simultaneously such narrow size distribution of the polysiloxane domains is hereinbelow also referred to as “fine polysiloxane domain size distribution”.

Preferably, in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%.

Particularly preferably, in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%.

Very particularly preferably, in the polysiloxane-polycarbonate block copolymer, the volume fraction of polysiloxane domains—measured based on the total volume of the polysiloxane domains—whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%.

To determine the size of the polysiloxane domains, polymer samples are cut at low temperature and subjected to examination by scanning electron microscopy as more particularly described below. In the context of the present invention, the diameter of a polysiloxane domain is to be understood as meaning the diameter of the equivalent area of a circle of the cross section of the polysiloxane domain visible in the cut.

It is known that polysiloxane-polycarbonate block copolymers exhibit good properties in terms of low-temperature impact strength/low-temperature notched impact strength, chemicals resistance and exterior weathering resistance as well as ageing characteristics and fire resistance. They are superior to conventional polycarbonates, i.e. standard polycarbonates, in terms of these properties. In the context of the present invention, a conventional polycarbonate or standard polycarbonate is to be understood as meaning a homopolycarbonate based on bisphenol-A.

In the context of the present invention, the relative solution viscosity is determined with an Ubbelohde viscometer in each case in dichloromethane at a concentration of 5 g/l at 25° C.

### DESCRIPTION OF RELATED ART

According to the prior art, polysiloxane-polycarbonate block copolymers are produced industrially via the so-called phase interface process with phosgene starting from bisphenol monomers and polydiorganosiloxanes. The production of polysiloxane-polycarbonate block copolymers starting from bisphenol monomers and polydiorganosiloxanes via the so-called melt transesterification process using diphenyl carbonate is also known from the prior art.

In the case of the phase interface process, the production of polysiloxane-polycarbonate block copolymers according to the prior art has the disadvantage that starting materials with special handling requirements such as phosgene are required. Furthermore, if an industrial plant configured for producing standard polycarbonate is used for producing polysiloxane-polycarbonate block copolymers, in the melt transesterification process the residence times of the reaction mixtures for producing the polysiloxane-polycarbonate block copolymers at high temperatures in the reactors are very lengthy. This severely increases the thermal stress on the polysiloxane-polycarbonate block copolymers, which has an adverse effect on the properties of the polysiloxane polycarbonate block copolymers.

The production of polysiloxane-polycarbonate block copolymers by the phase interface process is known from the literature and described, for example, in U.S. Pat. No. 3,189,662 A or EP 0 122 535 A2.

U.S. Pat. No. 5,504,177 A describes the production of a polysiloxane-polycarbonate block copolymer by melt transesterification from a carbonate-terminated polysiloxane with a bisphenol, in particular bisphenol-A, and a diaryl carbonate, in particular diphenyl carbonate, wherein U.S. Pat. No. 5,504,177 also elaborates on the disadvantages of the phase interface process. Due to the high incompatibility of polysiloxane with bisphenols and diaryl carbonates, obtaining a fine polysiloxane domain size distribution upon incorporation of the polysiloxanes into the polycarbonate matrix in the melt transesterification process is achievable only with great difficulty.

The production of polysiloxane-polycarbonate block copolymers in the melt transesterification process is known from the literature and described, for example, in EP 0 864 599 B1 or in EP 0 770 636 A2. The reaction times disclosed therein are not economically useful for a large industrial scale process. This document does not contain any practical teaching of how to shorten reaction times and thus also residence times.

EP 0 770 636 A2 does also disclose that small polysiloxane domain sizes down to 15 nm are achievable, but the polysiloxane domain size distribution apparent only from the figures is not useful for present-day demands. It is moreover not disclosed how a fine polysiloxane domain size distribution is obtainable.

A broad, i.e. not fine, polysiloxane domain size distribution in a polysiloxane-polycarbonate block copolymer has adverse effects on the aesthetic appearance and/or the mechanical properties of mouldings produced from a polysiloxane-polycarbonate block copolymer. Large polysiloxane domains can lead to demixing of the polysiloxane phase from the polycarbonate phase in the polysiloxane-polycarbonate block copolymer which manifests in an inhomogeneous surface structure of the polysiloxane-polycarbonate block copolymer and can result in flow lines and striping and in undesired optical interferences in an injection-moulded shaped body made of polysiloxane-polycarbonate block copolymer. The aesthetic appearance of such a shaped body is inadequate and such a shaped body is no longer uniformly colourable and is thus unsuitable for many commercial uses. Since large polysiloxane domains are shear-sensitive and can cause delamination in a shaped body produced from such a polysiloxane-polycarbonate block copolymer by injection moulding, such polysiloxane-polycarbonate block copolymers are moreover difficult to process in injection moulding with the result that often only very low injection speeds are employable, which is undesirable since it prolongs the cycle time.

Furthermore, neither EP 864 599 B1 nor EP 0 770 636 A2 give any indication of how to adjust the flowability of the obtained polysiloxane-polycarbonate block copolymers.

A person skilled in the art is aware of what is to be understood by a polysiloxane domain and this may be found for example both in the publication “Structure to Property Relationship in Polycarbonate/Polydimethylsiloxane Copolymers”, Matthew R. Pixton, published in “Associacao Brasileira de Polimeros, Sao Paulo, SP (Brazil); [vp.]; 2005; 2 p; 8. Brazilian congress on polymers; 8. congresso brasileiro de polimeros; Aguas de Lindoia, SP (Brazil); 6-10 Nov. 2005” and in the publication “Structure to Property Relationship in Polycarbonate/Polydimethylsiloxane Copolymers”, Matthew R. Pixton, published in “ANTEC 2006, Annual Technical Conference, Charlotte, North Carolina, May 7-11, 2006, Conference Proceedings, pages 2655-2659”.

It is known in principle that additives can be used to reduce the volume fraction of large polysiloxane domains in the polysiloxane-polycarbonate block copolymer. The addition of compatibilizers is described, for example, in EP 3719077 A1/WO 2020201178 A1. However the compatibilizers described therein are very costly, thus markedly increasing the raw material costs of the polysiloxane-polycarbonate block copolymer. Other compatibilizers are also disadvantageous since they are very costly or not employable on account of the high temperatures in the melt transesterification process since they undergo decomposition or result in a product having inadequate melt stability.

### SUMMARY

Starting from the recited prior art, it was therefore an object of the present invention to overcome at least one disadvantage of the prior art. It was especially an object of the present invention to provide a process for producing a polysiloxane-polycarbonate block copolymer which makes it possible to produce a polysiloxane-polycarbonate block copolymer with fine polysiloxane domain size distribution in conjunction with good flowability. Good flowability is advantageous since during further processing of a polysiloxane-polycarbonate block copolymer in injection moulding, it allows the production of parts having complex geometry and thin wall thicknesses. It was a further object of the invention to configure the process such that the process allows short residence times and is cost-effective and eschews starting materials with special handling requirements such as phosgene. In the present context, residence time is to be understood as meaning the time required to produce the desired polysiloxane-polycarbonate block copolymer with the desired relative solution viscosity by incorporation of the polysiloxane component; in the processes according to the invention described below, the residence time coincides with the reaction time.

The process shall be capable of continuous operation. In addition, it was a further object of the invention to be able to eschew costly compatibilizers.

It shall be the case that in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%.

It shall preferably be the case that in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%.

It shall particularly preferably be the case that in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%.

It shall very particularly preferably be the case that in the polysiloxane-polycarbonate block copolymer, the volume fraction of polysiloxane domains—measured based on the total volume of the polysiloxane domains—whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%.

At the same time the flowability shall remain high. However, the flowability shall not exceed a value where it leads to poorer mechanical properties of a moulding produced—in particular by injection moulding—from the polysiloxane-polycarbonate block copolymer produced by the process according to the invention. Relative solution viscosity may be regarded as a measure for flowability. Thus the relative solution viscosity of a polysiloxane-polycarbonate block copolymer produced by the process according to the invention having a polysiloxane content of 2% to 15% by weight, preferably of 3% to 10% by weight, particularly preferably having a polysiloxane content of 4% to 8% by weight, shall preferably be from 1.24 to 1.38, preferably from 1.26 to 1.36, particularly preferably from 1.27 to 1.35. A polysiloxane-polycarbonate block copolymer produced according to the invention is readily processable, for example by injection moulding or extrusion, in this range of relative solution viscosity.

Very particularly preferably, the relative solution viscosity of a polysiloxane-polycarbonate block copolymer produced by the process according to the invention having a polysiloxane content of 4.5% to 5.5% by weight shall be from 1.24 to 1.34, preferably from 1.26 to 1.33, particularly preferably from 1.27 to 1.32.

Here too it shall be the case that in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%.

Here too it shall preferably be the case that in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%.

Here too it shall particularly preferably be the case that in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%.

Here too it shall very particularly preferably be the case that in the polysiloxane-polycarbonate block copolymer, the volume fraction of polysiloxane domains—measured based on the total volume of the polysiloxane domains—whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%.

A polysiloxane-polycarbonate block copolymer produced according to the invention is especially readily processable, for example by injection moulding or extrusion, in this very particularly preferred range of relative solution viscosity.

This applies especially when the polysiloxane-polycarbonate block copolymer produced by the process according to the invention has a polysiloxane content of 4.5% to 5.5% by weight.

It is further particularly preferable when a polysiloxane-polycarbonate block copolymer produced by the process according to the invention exhibits tough fracture behaviour down to −60° C. in the notched impact test according to ISO 7391/ISO 180A, even at low polysiloxane contents.

These objects are achieved by a process for producing a polysiloxane-polycarbonate block copolymer, wherein this process is characterized by the use of precisely one thin-film evaporator or alternatively by the use of two or more serially arranged thin-film evaporators, wherein particular process conditions are maintained in each case.

### BRIEF DESCRIPTION OF THE DRAWINGS

FIG. 1 shows the experimental setup for certain of the Examples.

FIG. 2 shows the experimental setup for a twin-screw extruder.

FIG. 3 shows the experimental setup for a high-viscosity reactor.

FIG. 4 shows the experimental setup using precisely 1 thin-film evaporator.

### DESCRIPTION

In the context of the present invention, a thin-film evaporator is to be understood as meaning a vertically arranged apparatus which comprises an axially extending rotationally symmetrical—preferably cylindrical—reaction chamber which is supplied at its upper end with a reaction mixture composed of a polymer melt and a liquid polysiloxane in the form of a melt dispersion, said mixture being discharged from the apparatus at its lower end in the form of a further-reacted reaction mixture, and which is fitted with a rotor comprising at least two wiper blade elements, generally three, four or more wiper blade elements, at the circumference. Each wiper blade element has an outer edge, wherein the outer edge of a wiper blade element extends axially and is oriented towards the inner surface area of the axially extending rotationally symmetrical reaction chamber and spreads out the reaction mixture on the inner circumference of the axially extending rotationally symmetrical reaction chamber and thus always ensures surface renewal of the reaction mixture. The inner surface area of the reaction chamber has the same geometric shape as the reaction chamber, i.e. a cylindrical reaction chamber also has a cylindrical inner surface area. A wiper blade element may therefore be arranged axially parallel or at a working angle to the longitudinal axis. Thin-film evaporators that are suitable in principle for performing the process according to the invention are disclosed, for example, in EP3318311A1, EP1792643A1, DE19535817A1, DE102012103749A1, DE2011493A1 or DD-226778B1 or in the publication [1] “Platzer (ed.): Polymerization Kinetics and Technology, Advances in Chemistry; American Chemical Society: Washington, DC, 1973, pages 51 to 67: Fritz Widmer: Behaviour of Viscous Polymers during Solvent Stripping or Reaction in an Agitated Thin Film; Swiss Federal Institute of Technology, Zurich, Switzerland”, wherein the thin-film evaporator disclosed in DE19535817A1, DD-226778B1 or in EP3318311A1 or the thin-film evaporator disclosed in [1], FIG. 7, page 58, and FIG. 9, page 60, is especially suitable for performing the process according to the invention. Furthermore, options for configuring thin-film evaporators are disclosed in the article “Scaleup of Agitated Thin-film Evaporators”, William B. Glover, reprinted from Chemical Engineering, April 2004.

The spreading out of the melt of the reaction mixture on the inner surface area of the reaction chamber of the thin-film evaporator is important, since the polycondensation of the oligocarbonate and the polysiloxane to afford the polysiloxane-polycarbonate block copolymer requires effective removal by evaporation of a hydroxyl compound—generally phenol—formed during the polycondensation and thus requires constant surface renewal. Such tasks, where a large surface area coupled with good surface renewal is to be generated, generally require reactors such as rotating-disc reactors or other high viscosity reactors where the residence time of the reaction mixture in the reactor is, however, from 60 to 180 minutes. In the polycondensation for producing standard polycarbonates, the use of rotating-disc reactors in particular is described in the prior art, for example in U.S. Pat. No. 2,002,188 091 A1 or DE 101 42 735 A1.

It was therefore entirely surprising that rotating-disc reactors or other high-viscosity reactors are unsuitable for production of a polysiloxane-polycarbonate block copolymer having a good combination of narrow polysiloxane domain size distribution and good flowability since they do not ensure a sufficiently fine size distribution of the polysiloxane domains even when using a costly compatibilizer.
(1) The objects are in particular achieved in a first embodiment of the invention by a:
Process for continuous production of a polysiloxane-polycarbonate block copolymer using precisely one thin-film evaporator,
   wherein the process is characterized by the following process steps:
   (1) providing a reaction mixture containing an oligocarbonate having a relative solution viscosity of 1.08 to 1.22 and having an OH group content of 1000 to 2500 ppm and containing a hydroxyaryl-terminated polysiloxane,
   (2) introducing the reaction mixture provided in step (1) containing an oligocarbonate and a hydroxyaryl-terminated polysiloxane into the precisely one thin-film evaporator, wherein the thin-film evaporator comprises precisely one reaction chamber with precisely one rotor having at least two wiper blade elements at the circumference, wherein the precisely one rotor rotates in the thin-film evaporator and wherein each wiper blade element has one outer edge,
   (3) reacting the reaction mixture from step (2) to afford a polysiloxane-polycarbonate block copolymer, wherein the reaction mixture is conveyed from the intake of the thin-film evaporator to the outlet of the thin-film evaporator,
   (4) discharging the polysiloxane-polycarbonate block copolymer obtained in step (3) from the thin-film evaporator,
   wherein in step (3), in the precisely one thin-film evaporator, the following process conditions are observed:
   (3.a) shear rate between the outer edge of the at least two rotating wiper blade elements at the circumference and the axially extending rotationally symmetrical inner surface area of the reaction chamber of the thin-film evaporator of 500 l/s to 5000 l/s,
   (3.b) pressure in the reaction chamber of the thin-film evaporator of 0.01 mbara to 10 mbara,
   (3.c) temperature of the reaction mixture in the reaction chamber of 280° C. to 370° C.,
   (3.d) frequency of surface renewal of the reaction mixture of 10 to 50 Hz.
(2) Alternatively, the objects are achieved in a second embodiment of the invention by a:
Process for continuous production of a polysiloxane-polycarbonate block copolymer using a number of serially arranged thin-film evaporators, wherein this number is at least two,
   wherein the process is characterized by the following process steps:
   (1) providing a reaction mixture containing an oligocarbonate having a relative solution viscosity of 1.08 to 1.22 and having an OH group content of 1000 to 2500 ppm and containing a hydroxyaryl-terminated polysiloxane,
   (2) introducing the reaction mixture provided in step (1) containing an oligocarbonate and a hydroxyaryl-terminated polysiloxane into the first of the at least two serially arranged thin-film evaporators,
   wherein each of the at least two thin-film evaporators comprises precisely one reaction chamber having precisely one rotor, each rotor having at least two wiper blade elements at the circumference, wherein the precisely one rotor in each thin thin-film evaporator rotates and wherein each wiper blade element has one outer edge,
   (3) reacting the reaction mixture from step (2) to afford a polysiloxane-polycarbonate block copolymer,
   wherein the reaction mixture is conveyed from the intake of the first thin-film evaporator of the at least two serially arranged thin-film evaporators to the outlet of the last thin-film evaporator of the at least two serially arranged thin-film evaporators,
   (4) discharging the polysiloxane-polycarbonate block copolymer obtained in step (3) from the last thin-film evaporator,
   wherein in step (3), in the last of the at least two serially arranged thin-film evaporators, the following process conditions are observed:
   (3.a) shear rate between the outer edge of the at least two rotating wiper blade elements at the circumference and the axially extending rotationally symmetrical inner surface area of the reaction chamber of the thin-film evaporator of 500 l/s to 5000 l/s,
   (3.b) pressure in the reaction chamber of the thin-film evaporator of 0.01 mbara to 10 mbara, (3.c) temperature of the reaction mixture in the reaction chamber of 280° C. to 370° C., (3.d) frequency of surface renewal of the reaction mixture of 10 to 50 Hz.

Both in the first embodiment of the process according to the invention and in the second embodiment of the process according to the invention it is the case that:

Pressure measurement may be effected using for example WIKA IS-3 or Endress+Hauser Cerabar pressure sensors. It is however also possible to use other suitable prior art pressure sensors known to those skilled in the art.

Measurement of the temperature of the reaction mixture may be effected for example using type L thermocouples or Pt100 resistance thermometers whose measurement tip is immersed sufficiently deep into the reaction mixture. It is however also possible to use other suitable prior art means of temperature measurement known to those skilled in the art. Temperature measurement in the interior of the thin-film evaporator may be effected in the manner known from EP3318311A1.

The speed of rotation may preferably be measured via an initiator/pulser from the prior art on the rotor in a manner known to those skilled in the art. It is however also possible to use other suitable tachometers known to those skilled in the art. The frequency of surface renewal is obtained by multiplying the speed of rotation by the number of wiper blade elements at the circumference.

The shear rate is calculated by dividing the rotational speed of the rotor—determined from the inner circumference of the treatment chamber and the speed of the rotor—by the width of the gap between the rotor tip and the housing wall.

Both in the first embodiment of the process according to the invention and in the second embodiment of the process according to the invention, the residence time of the reaction mixture in step (3) is preferably 2 to 12 minutes, particularly preferably 3 to 10 minutes.

Both in the first embodiment of the process according to the invention and in the second embodiment of the process according to the invention, the polysiloxane-polycarbonate block copolymers produced therewith are thus all obtainable in short residence times.

In the second embodiment of the present invention, the number of serially arranged thin-film evaporators may be two or three or four or more serially arranged thin-film evaporators.

It is preferable according to the invention when in the second embodiment of the present invention, the number of serially arranged thin-film evaporators is precisely two.

A thin-film evaporator employable according to the invention is characterized in that the thin-film evaporator comprises at least two wiper blade elements at the circumference which are rotatable in the thin-film evaporator. The thin-film evaporator preferably comprises more than two wiper blade elements, in particular three, four or more wiper blade elements, at the circumference which are rotatable in the thin-film evaporator.

At least a portion of the axially extending rotationally symmetrical inner surface area of the axially extending rotationally symmetrical reaction chamber of a thin-film evaporator also serves as a heat transfer area. Heat may be supplied to the reaction chamber via the heat transfer area or heat may be removed from the reaction chamber via the heat transfer area. In a thin-film evaporator, the proportion of the reaction mixture-supplied, axially extending rotationally symmetrical inner surface area of the axially extending rotationally symmetrical reaction chamber serving as heat transfer area is from 90% to 100%, preferably 100%.

Both in the first embodiment of the process according to the invention and in the second embodiment of the process according to the invention, the temperature of the heat transfer area is from 280° C. to 340° C. so that any heat formed in process step (3) during the reaction of the reaction mixture, for example through the shear of the reaction mixture, may be removed via the heat transfer area. The heat transfer area may have a temperature profile or comprise two or more temperature zones or both.

In the context of the present invention, the term “mbara” stands for the unit “mbar absolute” for reporting absolute pressure in mbar.

In step (1), the reaction mixture is preferably provided by producing the oligocarbonate by polycondensation and mixing it with a hydroxyaryl-terminated polysiloxane previously produced elsewhere. However, it is also possible for a reaction mixture previously produced elsewhere to be plasticized and provided as a melt.

Both in the first embodiment of the process according to the invention and in the second embodiment of the process according to the invention, it is the case that the reaction mixture in process step (1) and the polysiloxane-polycarbonate block copolymer obtained upon discharge from the last thin-film evaporator of a number of serially arranged thin-film evaporators and the reaction mixtures intermediately formed from the reaction mixture in process step (1) in the reaction to afford the polysiloxane-polycarbonate block copolymer are in molten form. In the first embodiment of the process according to the invention, the sole thin-film evaporator may be regarded as the last thin-film evaporator.

Both the polysiloxane-polycarbonate block copolymer obtained according to the first embodiment of the process according to the invention and the polysiloxane-polycarbonate block copolymer obtained according to the second embodiment of the process according to the invention preferably have the following features:
The polysiloxane domains have a fine size distribution, i.e.:
in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%; at the same time the relative solution viscosity is from 1.38 to 1.24, preferably from 1.36 to 1.26, particularly preferably from 1.35 to 1.27; this relative solution viscosity is also referred to as the desired relative solution viscosity.
Preferably, in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%; here too the relative solution viscosity is from 1.36 to 1.24, preferably from 1.36 to 1.26, particularly preferably from 1.35 to 1.27; here too this relative solution viscosity is also referred to as the desired relative solution viscosity.
Particularly preferably, in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%; here too the relative solution viscosity is from 1.38 to 1.24, preferably from 1.36 to 1.26, particularly preferably from 1.35 to 1.27; here too this relative solution viscosity is also referred to as the desired relative solution viscosity.
Very particularly preferably, in the polysiloxane-polycarbonate block copolymer, the volume fraction of polysiloxane domains—measured based on the total volume of the polysiloxane domains—whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%; here too the relative solution viscosity is from 1.38 to 1.24, preferably from 1.36 to 1.26, particularly preferably from 1.352 to 1.27; here too this relative solution viscosity is also referred to as the desired relative solution viscosity.

Both the polysiloxane-polycarbonate block copolymer obtained according to the first embodiment of the process according to the invention and the polysiloxane-polycarbonate block copolymer obtained according to the second embodiment of the process according to the invention is superior to polysiloxane-polycarbonate block copolymers from the prior art having a polysiloxane content of 2% to 15% by weight, even to polysiloxane-polycarbonate block copolymers from the prior art having a polysiloxane content of 3% to 10% by weight, and even to polysiloxane polycarbonate block copolymers from the prior art having a polysiloxane content of 4% to 8% by weight, wherein the polysiloxane content refers to the total weight of the polysiloxane-polycarbonate block copolymer. This is the case especially when comparing a polysiloxane-polycarbonate block copolymer produced according to the invention with a polysiloxane-polycarbonate block copolymer produced by the melt transesterification process.

Provided that the polysiloxane-polycarbonate block copolymer produced by the process according to the invention has a polysiloxane content of 4.5% to 5.5% by weight, this polysiloxane-polycarbonate block copolymer has a relative solution viscosity of 1.24 to 1.34, preferably of 1.26 to 1.33, particularly preferably of 1.27 to 1.32, wherein here too it is the case that:

The polysiloxane domains have a fine size distribution, i.e.:
in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%.

Preferably, in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%.

Particularly preferably, in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%.

Very particularly preferably, in the polysiloxane-polycarbonate block copolymer, the volume fraction of polysiloxane domains—measured based on the total volume of the polysiloxane domains—whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%.

The advantageous relative solution viscosity of a polysiloxane-polycarbonate block copolymer produced by the process according to the invention having a polysiloxane content of 4.5% to 5.5% means that the abovementioned advantages of such a polysiloxane-polycarbonate block copolymer are attained to a particularly great extent. In particular, such a polysiloxane-polycarbonate block copolymer is particularly readily processable, for example by injection moulding or extrusion.

The very particularly preferred range is selected such that a polysiloxane-polycarbonate block copolymer having this polysiloxane content in conjunction with the specified relative solution viscosity can achieve good mechanical properties and good processability. The relative solution viscosity which is elevated especially in the case of higher polysiloxane contents can have the result that processability is no longer optimal. However, it is possible through admixture of conventional polycarbonate having a lower relative solution viscosity to establish a polysiloxane content which corresponds to the very particularly preferred range. Such a mixture then once again features the good mechanical properties in conjunction with good flowability. A person skilled in the art is familiar with the mixing/compounding of conventional polycarbonate with a polysiloxane-polycarbonate block copolymer, especially also with the relative solution viscosity that the conventional polycarbonate must have to achieve the desired relative solution viscosities of a mixture of conventional polycarbonate with a polysiloxane-polycarbonate block copolymer. The particularly preferred range is thus not limiting since, especially at high polysiloxane contents in the polysiloxane-polycarbonate block copolymer, the combination of polysiloxane content and relative solution viscosity is achievable through prior art compounding of a polysiloxane-polycarbonate block copolymer with conventional polycarbonate. However, it is also the case that at excessive values of relative solution viscosity of a polysiloxane-polycarbonate block copolymer having a high polysiloxane content, these high values of relative solution viscosity cannot be reduced to values of relative solution viscosity at which good processability of the polysiloxane polycarbonate block copolymer is still assured by admixture of conventional polycarbonate having a lower relative solution viscosity.

A polysiloxane-polycarbonate block copolymer produced by the process according to the invention also exhibits tough fracture behaviour down to −60° C. in the notched impact test according to ISO 7391/ISO 180A, even at low polysiloxane contents.

This is surprising since the high shear rates employed in step (3.a) subject the reaction mixture containing oligocarbonate and hydroxyaryl-terminated polysiloxane and in particular the polysiloxane-polycarbonate block copolymer formed therefrom to high mechanical, and especially thermal, stress. Thermal stress results in undesired side reactions which can result in undesired discolouration, in particular yellowing, of the polysiloxane-polycarbonate block copolymer and in poorer mechanical properties, in particular poorer low-temperature impact strength, of a moulding produced from the polysiloxane-polycarbonate block copolymer produced by the process according to the invention.

A person skilled in the art would thus have tried to avoid producing a polysiloxane-polycarbonate block copolymer using such a high shear rate.

However, it has now been found that in a process for producing a polysiloxane-polycarbonate block copolymer with the use of selected high shear rates with simultaneous application of a selected low pressure, selected temperatures and selected frequency of surface renewal, lower-thermal-stress process conditions can be achieved.

This was surprising to a person skilled in the art. It was especially also surprising to a person skilled in the art that this was also achieved in the second embodiment—i.e. using at least two serially arranged thin-film evaporators—despite no compatibilizer being employed.

It is preferable according to the invention when, in process step (3) in the single thin-film evaporator or in the last thin-film evaporator of a number of serially arranged thin-film evaporators, the following process condition is observed:

(3.a.a) that the shear rate between the rotating outer edge of a wiper blade element and the axially extending rotationally symmetric inner surface area of the reaction chamber of the thin-film evaporator is from 500 l/s to 4000 l/s.

This preferred embodiment of the process according to the invention is a third embodiment according to the abovementioned first embodiment or the abovementioned second embodiment.

It is also preferable according to the invention when, in process step (3) in the single thin-film evaporator or in the last thin-film evaporator of a number of serially arranged thin-film evaporators, the following process condition is observed:

(3.b.a) that the pressure in the reaction chamber of the thin-film evaporator is from 0.1 mbara to 6 mbara, preferably from 0.2 mbara to 2 mbara.

This more preferred embodiment of the process according to the invention is a fourth embodiment according to the abovementioned first embodiment or the abovementioned second embodiment.

It is also preferable according to the invention when the relative solution viscosity of the oligocarbonate provided in step (1) is from 1.11 to 1.22, particularly preferably 1.13 to 1.20.

This very particularly preferred embodiment of the process according to the invention is a fifth embodiment according to the abovementioned first embodiment or the abovementioned second embodiment.

It is likewise preferable according to the invention when the polysiloxane content of both the polysiloxane-polycarbonate block copolymer produced according to the first embodiment of the process according to the invention and the polysiloxane-polycarbonate block copolymer produced according to the second embodiment of the process according to the invention is from 2% to 15% by weight, wherein the polysiloxane content is based on the total weight of the polysiloxane-polycarbonate block copolymer.

This more preferred embodiment of the process according to the invention is a sixth embodiment according to the abovementioned first embodiment or the abovementioned second embodiment.

It is particularly preferable according to the invention when the polysiloxane content of the polysiloxane-polycarbonate block copolymer is from 3% to 10% by weight, wherein the polysiloxane content is based on the total weight of the polysiloxane-polycarbonate block copolymer.

This particularly preferred embodiment of the process according to the invention is a seventh embodiment according to the abovementioned sixth embodiment.

It is very particularly preferable according to the invention when the polysiloxane content of the polysiloxane-polycarbonate block copolymer is from 4% to 8% by weight, wherein the polysiloxane content is based on the total weight of the polysiloxane-polycarbonate block copolymer.

This very particularly preferred embodiment of the process according to the invention is an eighth embodiment according to the abovementioned seventh embodiment.

It is especially particularly preferable according to the invention when the polysiloxane content of the polysiloxane-polycarbonate block copolymer is from 4.5% to 5.5% by weight, wherein the polysiloxane content is based on the total weight of the polysiloxane-polycarbonate block copolymer.

This very particularly preferred embodiment of the process according to the invention is a ninth embodiment according to the abovementioned eighth embodiment.

It is further preferable according to the invention when the OH group content of the oligocarbonate provided in step (1) is from 1200 to 2300 ppm, particularly preferably from 1400 to 2200 ppm.

This more preferred embodiment of the process according to the invention is a tenth embodiment according to the abovementioned first embodiment or the abovementioned second embodiment.

It is additionally preferred according to the invention when in step (1) the reaction mixture containing an oligocarbonate having a relative solution viscosity of 1.08 to 1.22, preferably having a solution viscosity of 1.11 to 1.22, particularly preferably having a relative solution viscosity of 1.13 to 1.20, and having an OH group content of 1000 to 2500 ppm, preferably having an OH group content of 1200 to 2300 ppm, particular preferably having an OH group content of 1400 to 2200 ppm, and containing a hydroxyaryl-terminated polysiloxane is produced using dynamic and/or static mixers.

This additionally preferred embodiment of the process according to the invention is an eleventh embodiment according to the abovementioned first embodiment or the abovementioned second embodiment.

In the case where the number of serially arranged thin-film evaporators is at least two, the following process conditions are preferably observed in step (3) of the process:
in the first thin-film evaporator:
(3.1.a) shear rate between the outer edge of a rotating wiper blade element and the axially extending rotationally symmetrical inner surface area of the reaction chamber of the thin-film evaporator of 500 l/s to 5000 l/s,
(3.1.b) pressure in the reaction chamber of 1 mbara to 10 mbara,
(3.1.c) temperature of the reaction mixture in the reaction chamber of 270° C. to 350° C.,
(3.1.d) frequency of surface renewal of the reaction mixture of 10 to 30 Hz,
and in the last thin-film evaporator:
(3.2.a) shear rate between the outer edge of the at least two rotating wiper blade elements and the axially extending rotationally symmetrical inner surface area of the reaction chamber of the thin-film evaporator of 500 l/s to 4000 l/s, preferably of 500 l/s to 2000 l/s,
(3.2.b) pressure in the reaction chamber of 0.1 mbara to 3 mbara, preferably 0.2 to 2 mbara,
(3.2.c) temperature of the reaction mixture in the reaction chamber of 280° C. to 370° C.,
(3.2.d) frequency of surface renewal of the reaction mixture of 10 to 30 Hz.

This embodiment of the process according to the invention is a twelfth embodiment according to the abovementioned second embodiment.

According to the invention, the term “intermediate polysiloxane-polycarbonate block copolymer” as obtained for example in step (3) is used for distinction from the polysiloxane-polycarbonate block copolymer as obtained for example in step (6). The term “intermediate” is accordingly used to make it clear that the intermediate polysiloxane-polycarbonate block copolymer has a lower molecular weight than the polysiloxane-polycarbonate block copolymer. The intermediate polysiloxane-polycarbonate block copolymer thus has a lower relative solution viscosity than the polysiloxane-polycarbonate block copolymer. The intermediate polysiloxane-polycarbonate block copolymer thus has a relative solution viscosity of 1.20 to 1.27. It will be understood that the adjective “intermediate” in the term “intermediate polysiloxane-polycarbonate block copolymer” refers to the formed repeating units of the hydroxyaryl-terminated polysiloxane (which is already a polymer) and the oligocarbonate (which is already an oligomer) and that an intermediate polysiloxane-polycarbonate block copolymer may especially also be a “polymer”. However, in contradistinction to the end product, the intermediate polysiloxane-polycarbonate block copolymer has fewer formed repeating units. It is apparent to a person skilled in the art that the use of an oligocarbonate having a lower relative solution viscosity generally also results in an intermediate polysiloxane-polycarbonate block copolymer having a lower relative solution viscosity being obtained. It is also apparent to a person skilled in the art that the intermediate polysiloxane-polycarbonate block copolymer also contains further-condensed oligocarbonate having a higher relative solution viscosity than the oligocarbonate employed in step (1).

The two serially arranged thin-film evaporators are successively traversed by a reaction mixture for producing the polysiloxane-polycarbonate block copolymer and these thin-film evaporators are directly connected to one another via pipe conduits. It is preferable when no further reactor is present between these two thin-film evaporators. However, pumps or mixing elements, for example static or dynamic mixers, may be employed in the connection between the thin-film evaporators. These pumps or these mixing elements are not considered reactors since the purpose of these pump or these mixing elements is merely a mechanical treatment of a substance. The second thin-film evaporator may be followed by a further thin-film evaporator or two or more further thin-film evaporators, all arranged in series.

When using only one thin-film evaporator, the application rate with reaction mixture per unit inner surface area of the reaction chamber is from 20 kg/m²h to 100 kg/m²h of reaction mixture. When using more than one thin-film evaporator, the application rate with reaction mixture per unit inner surface area of the sum of the inner surface areas of the reaction chambers of the serially arranged thin-film evaporators is from 20 kg/m²h to 100 kg/m²h of reaction mixture; this applies especially when precisely two serially arranged thin-film evaporators are used for the process according to the invention.

The use of thin-film evaporators for polycondensation of polysiloxane-polycarbonate block copolymers is known in principle, for example from the abovementioned document EP 864 599 B1 or else from EP 0 770 636 A2. However, a detailed process using thin-film evaporators is not described, only the theoretical option of configuring a process via thin-film evaporators. Exemplary embodiments using thin-film evaporators are not specified. This document does not provide any practical teaching of how to run the process to allow production of a polysiloxane-polycarbonate block copolymer having a fine polysiloxane domain size distribution in conjunction with good flowability.

It has now further been demonstrated that the use of at least one thin-film evaporator makes it possible to markedly reduce residence times compared to the use of high viscosity reactors or rotating-disc reactors. This also applies when at least two thin-film evaporators are arranged in series.

This is surprising since it would be assumed that the at least two serially arranged thin-film evaporators would extend the total residence time of the reaction mixture provided in step (1) and the polysiloxane-polycarbonate block copolymer resulting therefrom in the at least two serially arranged thin-film evaporators compared to the use of only one thin-film evaporator. This would be expected to increase the thermal stress on the resulting polysiloxane-polycarbonate block copolymer. This would in turn be expected to lead to undesired side reactions which would be expected to result in undesired discolouration, in particular yellowing, of the polysiloxane-polycarbonate block copolymer and in poorer mechanical properties, in particular poorer low-temperature impact strength, of a moulding produced from the polysiloxane-polycarbonate block copolymer produced by the process according to the invention.

A person skilled in the art would therefore have tried to avoid producing a polysiloxane-polycarbonate block copolymer using two or more serially arranged thin-film evaporators.

However, it has been found that in a process for producing a polysiloxane-polycarbonate block copolymer having a polysiloxane content of 2% to 15% by weight, preferably having a polysiloxane content of 3% to 10% by weight, particularly preferably having a polysiloxane content of 4% to 8% by weight, very particularly preferably having a polysiloxane content of 4.5% to 5.5% by weight, it is even possible to establish lower-thermal-stress process conditions when using at least two thin-film evaporators than when using only one thin-film evaporator.

It is also possible when using two thin-film evaporators to vary the process parameters, for example the frequency of surface renewal, temperature, pressure or shear rate, over a wider range so that the production process is less susceptible to failure and simpler to adjust to changing process conditions—for example different features of the oligocarbonate added in step (1) or the hydroxyaryl-terminated polysiloxane added in step (1).

The present invention further provides a polysiloxane-polycarbonate block copolymer comprising the following features:
Polysiloxane content of 2% to 15% by weight based on the total weight of polysiloxane-polycarbonate block copolymer,
the polysiloxane domains have a fine size distribution, i.e.:
in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%; simultaneously the relative solution viscosity is from 1.38 to 1.24, preferably from 1.36 to 1.26, particularly preferably from 1.35 to 1.27; here too this relative solution viscosity is also referred to as the desired relative solution viscosity.
Preferably, in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%; here too the relative solution viscosity is from 1.38 to 1.24, preferably from 1.36 to 1.26, particularly preferably from 1.35 to 1.27; here too this relative solution viscosity is also referred to as the desired relative solution viscosity.
Particularly preferably, in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%; here too the relative solution viscosity is from 1.38 to 1.24, preferably from 1.36 to 1.26, particularly preferably from 1.35 to 1.27; here too this relative solution viscosity is also referred to as the desired relative solution viscosity.
Very particularly preferably, in the polysiloxane-polycarbonate block copolymer, the volume fraction of polysiloxane domains—measured based on the total volume of the polysiloxane domains whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%; here too the relative solution viscosity is from 1.38 to 1.24, preferably from 1.36 to 1.26, particularly preferably from 1.35 to 1.27; here too this relative solution viscosity is also referred to as the desired relative solution viscosity.

Preferably, the polysiloxane-polycarbonate block copolymer according to the invention has a polysiloxane content of 3% to 10% by weight, particularly preferably a polysiloxane content of 4% to 8% by weight.

Provided that the polysiloxane-polycarbonate block copolymer produced by the process according to the invention has a polysiloxane content of 4.5% to 5.5% by weight, as is very particularly preferred, this polysiloxane-polycarbonate block copolymer has a relative solution viscosity of 1.24 to 1.34, preferably of 1.26 to 1.33, particularly preferably of 1.27 to 1.32, wherein here too it is the case that:

The polysiloxane domains have a fine size distribution, i.e.:

in the polysiloxane-polycarbonate block copolymer, the volume fraction of polysiloxane domains—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds 500 nm is less than 0.1%.

Preferably, in the polysiloxane-polycarbonate block copolymer, the volume fraction of polysiloxane domains—measured based on the total volume of the polysiloxane domains—whose diameter exceeds 100 nm is less than 60%, wherein simultaneously the volume fraction of polysiloxane domains whose diameter exceeds 200 nm is less than 20%, wherein simultaneously the volume fraction of polysiloxane domains whose diameter exceeds 500 nm is less than 0.1%.

Particularly preferably, in the polysiloxane-polycarbonate block copolymer, the volume fraction of polysiloxane domains—measured based on the total volume of the polysiloxane domains—whose diameter exceeds 100 nm is less than 50%, wherein simultaneously the volume fraction of polysiloxane domains whose diameter exceeds 200 nm is less than 10%, wherein simultaneously the volume fraction of polysiloxane domains whose diameter exceeds 500 nm is less than 0.1%.

Very particularly preferably, in the polysiloxane-polycarbonate block copolymer, the volume fraction of polysiloxane domains—measured based on the total volume of the polysiloxane domains—whose diameter exceeds 100 nm is less than 40%, wherein simultaneously the volume fraction of polysiloxane domains whose diameter exceeds 200 nm is less than 1%, wherein simultaneously the volume fraction of polysiloxane domains whose diameter exceeds 500 nm is less than 0.1%.

The advantageous relative solution viscosity of a polysiloxane-polycarbonate block copolymer produced by the process according to the invention having a polysiloxane content of 4.5% to 5.5% means that the abovementioned advantages of such a polysiloxane-polycarbonate block copolymer are attained to a particularly great extent. In particular, such a polysiloxane-polycarbonate block copolymer is particularly readily processable, for example by injection moulding or extrusion.

A polysiloxane-polycarbonate block copolymer produced by the process according to the invention also exhibits tough fracture behaviour down to −60° C. in the notched impact test according to ISO 7391/ISO 180A, even at low polysiloxane contents.

The present invention further provides for the use of the polysiloxane-polycarbonate block copolymer according to the invention for producing shaped bodies, in particular by injection moulding or extrusion.

The present invention further provides for the use of the polysiloxane-polycarbonate block copolymer according to the invention for producing housings, helmets, dishwasher-resistant household goods, viewing windows of kettles, control knobs and buttons, snap closures, cake and chocolate moulds, plug connectors for photovoltaic plants, couplings for photovoltaic plants.

In terms of the use for producing housings, the polysiloxane-polycarbonate block copolymer according to the invention is suitable for producing housings for the following articles:
medical devices, mobile electrical handheld devices, mobile scanners, mobile Play-Stations, mobile music players, wearables, sensors or computer devices for the Internet of things, mobile electrical charging devices, mobile electrical adapters, control means for mechanical engineering, smart meters, mobile wireless devices, tablet computers, charging stations for electrical devices, antenna housings for 5G base stations, exterior electrical applications, electrical junction boxes, cash machines, parking meters.

Both in the first embodiment of the process according to the invention and in the second embodiment of the process according to the invention, the production of the oligocarbonate employed in step (1) of the process according to the invention is carried out via the melt transesterification process, for example as disclosed in WO2019238419A1, whose disclosure content relating to production is hereby incorporated by reference into the present description. The production of an oligocarbonate useful for step (1) of the process according to the invention is also described in DE10119851A1, WO02077066A1, WO02077067A2 or WO02085967A1.

Discharging of the fully reacted molten polysiloxane-polycarbonate block copolymer from the last of the serially arranged thin-film evaporators—preferably also from the only thin-film evaporator if only one thin-film evaporator is used or from the second of the two thin-film evaporators if precisely two serially arranged thin-film evaporators are used—may be effected using a single-shaft screw, a twin-shaft screw or a gear pump. Discharging of the molten polysiloxane-polycarbonate block copolymer from the last of the serially arranged thin-film evaporators may optionally also be followed by supplying and incorporation of additives and/or additions. The incorporation of the additions may be carried out in the discharging apparatus or in a static mixer downstream of the discharging apparatus. The melt of the polysiloxane-polycarbonate block copolymer is then shaped by means of one or more nozzles and comminuted with a pelletizing device according to the prior art.

The finer polysiloxane domain size distribution in the polysiloxane-polycarbonate block copolymer produced by the process according to the invention results in an improved aesthetic appearance of the polysiloxane-polycarbonate block copolymer, for example a more homogeneous surface structure and reduced formation of flow lines or striping or undesired optical interferences in an injection-moulded shaped body made of the polysiloxane-polycarbonate block copolymer according to the invention. The tendency for demixing of the polysiloxane phase from the polycarbonate phase is reduced and the processing window for injection moulding of the polysiloxane-polycarbonate block copolymer produced according to the invention is broadened. The tendency for delamination in a shaped body produced from the polysiloxane-polycarbonate block copolymer produced according to the invention is also reduced.

This applies especially when the polysiloxane-polycarbonate block copolymer produced by the process according to the invention has a polysiloxane content of 4.5% to 5.5% by weight.

Shaped bodies produced from the polysiloxane-polycarbonate block copolymer produced according to the invention exhibit tough fracture behaviour down to −60° C. in the notched impact test according to ISO 7391/ISO 180A, even at low polysiloxane contents.

The oligocarbonate to be employed according to the invention and the hydroxyaryl-terminated polysiloxane to be employed according to the invention may be reacted using catalysts in step (3). A reaction mode without a catalyst is possible in principle but higher temperatures or longer residence times may have to be accepted as a result.

Catalysts suitable for the process according to the invention are for example:

ammonium catalysts such as, for example, tetramethylammonium hydroxide, tetramethylammonium acetate, tetramethylammonium fluoride, tetramethylammonium tetraphenylboranate, dimethyldiphenylammonium hydroxide, tetraethylammonium hydroxide, cetyltrimethylammonium tetraphenylboranate and cetyltrimethylammonium phenoxide. Especially suitable catalysts also include phosphonium catalysts of formula (K):

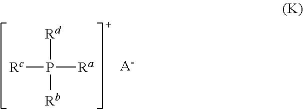

wherein R^{a}, R^{b}, R^{c} and R^{d} may be identical or different C1-C10-alkyls, C6-C14-aryls, C7-C15-arylalkyls or C5-C6-cycloalkyls, preferably methyl or C6-C14-aryls, particularly preferably methyl or phenyl, and A may be an anion such as hydroxide, sulfate, hydrogensulfate, hydrogencarbonate, carbonate or a halide, preferably chloride or an alkoxide or aroxide of formula —OR, wherein R may be C6-C14-aryl, C7-C15-arylalkyl or C5-C6-cycloalkyl, preferably phenyl.

Particularly preferred catalysts are tetraphenylphosphonium chloride, tetraphenylphosphonium hydroxide or tetraphenylphosphonium phenoxide; tetraphenylphosphonium phenoxide is very particularly preferred. It is particularly preferable to employ the alkali metal salts or alkaline earth metal salts of these ammonium and/or phosphonium catalysts.

The catalyst is preferably employed in amounts of 0.0001% to 1.0% by weight, preferably of 0.001% to 0.5% by weight, especially preferably of 0.005% to 0.3% by weight and very particularly preferably of 0.01% to 0.15% by weight, based on the weight of the employed oligocarbonate.

The catalyst may be employed alone or as a catalyst mixture and may be added in pure form or as a solution, for example in water or in phenol, for example as a solid solution with phenol. It may be introduced into the reaction for example by means of a masterbatch or preferably with the oligocarbonate or added separately/in addition.

It is likewise preferable when the oligocarbonate and the hydroxyaryl-terminated polysiloxane are reacted in the presence of an organic or inorganic salt of a weak acid having a pK_{A} in the range from 3 to 7 (25° C.). This salt may also be referred to as co-catalyst. Suitable weak acids comprise carboxylic acids, preferably C2-C22-carboxylic acids such as for example acetic acid, propanoic acid, oleic acid, stearic acid, lauric acid, benzoic acid, 4-methoxybenzoic acid, 3-methylbenzoic acid, 4-tert-butylbenzoic acid, p-tolueneacetic acid, 4-hydroxybenzoic acid and salicylic acid, partial esters of polycarboxylic acids, for example monoesters of succinic acid, partial esters of phosphoric acids, for example mono- or diorganic phosphoric esters, branched aliphatic carboxylic acids, such as for example 2,2-dimethylpropionic acid, 2,2-dimethylbutanoic acid, 2,2-dimethylpentanoic acid and 2-ethylhexanoic acid.

Suitable organic or inorganic salts are selected from or derived from hydrogen carbonate, potassium hydrogen carbonate, lithium hydrogen carbonate, sodium carbonate, potassium carbonate, lithium carbonate, sodium acetate, potassium acetate, lithium acetate, sodium stearate, potassium stearate, lithium stearate, sodium oleate, potassium oleate, lithium oleate, sodium benzoate, potassium benzoate, lithium benzoate, disodium, dipotassium or dilithium salts of bisphenol A. The salts may further comprise calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, strontium stearate and the corresponding oleates. The salts may be used alone or in any desired mixtures.

The salt is particularly preferably selected from the group consisting of alkali metal salts, alkaline earth metal salts and phosphonium salts of carboxylic acids. In a further preferred embodiment, the organic or inorganic salt is derived from a carboxylic acid.

The organic or inorganic salts are preferably employed in amounts of 0.08 to 10 ppm and very particularly preferably of 0.1 to 5 ppm based on the total weight of the polysiloxane and the organic or inorganic salt.

In a preferred embodiment, the organic or inorganic salt is a sodium salt, preferably a sodium salt of a carboxylic acid. It is preferably employed in an amount such that the sodium content in the resulting polysiloxane-polycarbonate block copolymer is in the range from 0.003 ppm to 0.5 ppm based on the total weight of the polysiloxane-polycarbonate block copolymer that is to be formed. The co-catalyst is preferably dissolved in the hydroxyaryl-terminated polysiloxane with a suitable solvent. The sodium content of the polysiloxane-polycarbonate block copolymer may for example be determined by atomic emission spectroscopy.

It is an advantage that the sodium content in the obtained polysiloxane-polycarbonate block copolymer is less than in the prior art since higher sodium contents can result in increased decomposition of the polysiloxane-polycarbonate block copolymer under thermal stress.

The organic or inorganic salt may be employed alone or in any desired mixtures. It may be added as a solid or in solution. In a preferred embodiment, the organic or inorganic salt is added in the form of a mixture containing the hydroxyaryl-terminated polysiloxane and the organic or inorganic salt.

The catalysts may be employed alone or in admixture and be added in pure form or as a solution, for example in water or in phenol.

It is especially preferable when the at least one catalyst is incorporated into the oligocarbonate and the co-catalyst is incorporated into the hydroxyaryl-terminated polysiloxane.

### Oligocarbonate (Component A)

An oligocarbonate (hereinbelow also referred to as component (A)) in the context of the present invention is preferably a homo-oligocarbonate. The oligocarbonate may be linear or branched in known fashion. Production of the oligocarbonate employed according to the invention is carried out as described above preferably by the melt transesterification process, in particular according to WO2019238419A1. Production of an oligocarbonate useful for the process according to the invention is also described in DE10119851A1, WO02077066A1, WO02077067A2 or WO02085967A1.

To produce the polysiloxane-polycarbonate block copolymer according to the invention it is preferable to employ an oligocarbonate having a molecular weight (Mw) of 5000 to 20 000 g/mol, particularly preferably of 8000 to 19 000 g/mol and especially preferably of 10 000 to 18 000 g/mol. This oligocarbonate preferably has a content of phenolic OH groups of 1000 ppm to 2500 ppm, preferably 1300 to 2300 ppm and especially preferably of 1400 to 2200 ppm. The phenolic OH groups are preferably determined by IR spectroscopy. In the context of the present invention, ppb and ppm are to be understood as meaning parts by weight unless otherwise stated.

The method used for determining the molar masses reported in the context of the invention for the oligocarbonate, the hydroxyaryl-terminated polysiloxane or the polysiloxane-polycarbonate block copolymer is method no. 2301-0257502-09D of Currenta GmbH & Co. OHG which is available from Currenta GmbH & Co. OHG upon request.

It is further preferable when an oligocarbonate having a relative solution viscosity of 1.08 to 1.22 is employed for producing the polysiloxane-polycarbonate block copolymer according to the invention. The solution viscosity (ηrel; also referred to as eta rel) is preferably determined using an Ubbelohde viscometer in dichloromethane at a concentration of 5 g/l at 25° C.

Preferred diphenols for producing the oligocarbonate are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,2-bis(3-methyl-4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,3-bis[2-(3,5-dimethyl-4-hydroxyphenyl)-2-propyl]benzene, 1,1-bis(4-hydroxyphenyl)cyclohexane and 1,1-bis(4-hydroxyphenyl)-3,3,5-trimethylcyclohexane.

Particularly preferred diphenols are 2,2-bis(4-hydroxyphenyl)propane (BPA), hydroquinone, 1,1-bis(4-hydroxyphenyl)-3,3,5-trimethylcyclohexane and 2,2-bis(3-methyl-4-hydroxyphenyl)propane.

The oligocarbonate is in particular a homo-oligocarbonate based on bisphenol-A. This homo-oligocarbonate very particularly preferably contains phenol as an end group.

An oligocarbonate bearing phenol as end groups (phenyl-terminated oligocarbonate) is also preferred. Tert-butylphenol and cumylphenol are further possible end groups.

The polysiloxane-polycarbonate block copolymer obtainable by the process according to the invention preferably contains at least one, particularly preferably two or more, of the following structures (4) to (7):

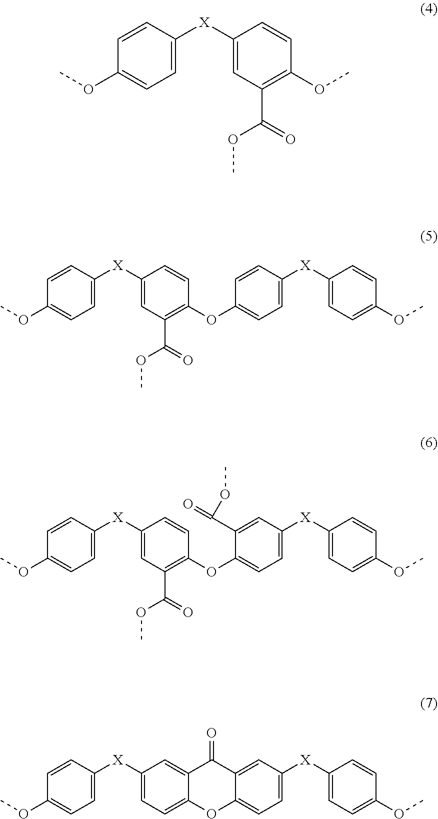

in which the phenyl rings may independently of one another be mono- or disubstituted with C1-C8 alkyl, halogen, preferably C1 to C4 alkyl, particularly preferably with methyl and X represents a single bond, C1 to C6 alkylene, C2 to C5 alkylidene or C5 to C6 cycloalkylidene, preferably a single bond or C1 to C4 alkylene and especially preferably isopropylidene, wherein the amount of structural units (4) to (7) in total (preferably determined through total hydrolysis using quantitative HPLC) is generally in the range from 50 to 1000 ppm, preferably in the range from 80 to 850 ppm. Thus also the polysiloxane-polycarbonate block copolymer produced according to the invention preferably comprises at least one, particularly preferably two or more, of the abovementioned structures (4) to (7).

In order to determine the amount of the rearrangement structures, the respective polysiloxane-polycarbonate block copolymer is subjected to a total hydrolysis to form the corresponding decomposition products of formulae (4a) to (7a), the amount of which is determined by HPLC. This can be accomplished for example as follows: a polysiloxane-polycarbonate block copolymer sample is hydrolysed under reflux using sodium methoxide. The corresponding solution is acidified and concentrated to dryness. The drying residue is dissolved in acetonitrile and the phenolic compounds of formulae (4a) to (7a) are determined using HPLC with UV detection, wherein the compound of formula (4a) is a decomposition product of the compound of formula (4) and wherein the compound of formula (5a) is a decomposition product of the compound of formula (5) and wherein the compound of formula (6a) is a decomposition product of the compound of formula (6) and wherein the compound of formula (7a) is a decomposition product of the compound of formula (7):

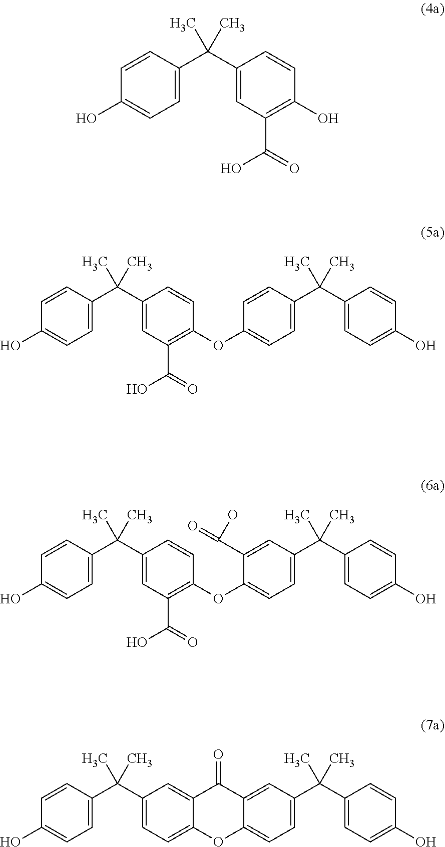 [SMILES: CC(C)(c1ccc(O)cc1)c1ccc(O)c(C(=O)O)c1 ; CC(C)(c1ccc(O)cc1)c1ccc(Oc2ccc(C(C)(C)c3ccc(O)cc3)cc2C(=O)O)cc1 ; CC(C)(c1ccc(O)cc1)c1ccc(Oc2ccc(C(C)(C)c3ccc(O)cc3)cc2C(=O)O)c(C(=O)O)c1 ; CC(C)(c1ccc(O)cc1)c1ccc2oc3ccc(C(C)(C)c4ccc(O)cc4)cc3c(=O)c2c1]

The amount of the thus-liberated compound of formula (4a) is preferably 10 to 500 ppm, particularly preferably 30 to 300 ppm.

The amount of the thus-liberated compound of formula (5a) is preferably 0 (i.e. below the detection limit of 10 ppm) to 100 ppm, particularly preferably 1 to 50 ppm.

The amount of the thus-liberated compound of formula (6a) is preferably 1 (i.e. below the detection limit of 10 ppm) to 100 ppm, more preferably 1 to 50 ppm.

The amount of the thus-liberated compound of formula (7a) is preferably 10 (i.e. at the detection limit of 10 ppm) to 300 ppm, preferably 20 to 250 ppm.

### Hydroxyaryl-Terminated Polysiloxane Component (B)

The polysiloxane used according to the invention is hydroxyaryl-terminated. This is to be understood as meaning that at least one end, preferably at least 2 ends, particularly preferably all ends (if more than 2 ends are present) of the polysiloxane have an OH end group.

Component B is preferably a hydroxyaryl-terminated polysiloxane of formula (1)

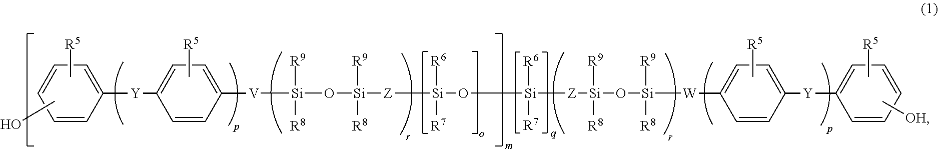

wherein
R⁵ is hydrogen or C₁- to C₄-alkyl, C₁- to C₃-alkoxy, preferably hydrogen, methoxy or methyl,
R⁶, R⁷, R⁸ and R⁹ each independently of one another are C₁- to C₄-alkyl or C₆- to C₁₂-aryl, preferably methyl or phenyl,
Y is a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or is a C₅- to C₆-cycloalkylidene radical which may be mono- or polysubstituted by C₁- to C₄-alkyl, preferably is a single bond, —O—, isopropylidene or a C₅- to C₆-cycloalkylidene radical which may be mono- or polysubstituted by C₁- to C₄-alkyl,
V is oxygen, C₂- to C₆-alkylene or C₃- to C₆-alkylidene, preferably oxygen or C₃-alkylene,
p, q and r are each independently 0 or 1,
when q=0: W is a single bond and preferably simultaneously r=0,
when q=1 and r=0: W is oxygen, C₂- to C₆-alkylene or C₃- to C₆-alkylidene, preferably oxygen or C₃-alkylene,
when q=1 and r=1: W and V each independently are oxygen or C₂- to C₆-alkylene or C₃- to C₆-alkylidene, preferably C₃-alkylene,
Z is a C₁- to C₆-alkylene, preferably C₂-alkylene,
o is an average number of repeating units of from 10 to 500, preferably 10 to 100, and
m is an average number of repeating units of from 1 to 10, preferably 1 to 6, more preferably 1.5 to 5. It is likewise possible to use diphenols in which two or more siloxane blocks of general formula (1a) are joined to one another via terephthalic acid and/or isophthalic acid to form ester groups.

Especial preference is given to (poly)siloxanes of formulae (2) and (3)

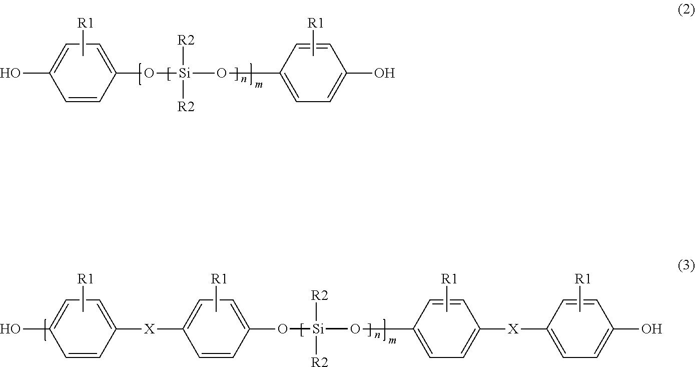

in which R1 is hydrogen, C₁- to C₄-alkyl, preferably hydrogen or methyl and especially preferably hydrogen,
each R2 independently is aryl or alkyl, preferably methyl,
X is a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X preferably is a single bond, C₁- to C₅-alkylene, C₂- to C₅-alkylidene, C₅- to C₁₂-cycloalkylidene, —O—, —SO— —CO—, —S—, —SO₂—, particularly preferably X is a single bond, isopropylidene, C₅- to C₁₂-cycloalkylidene or oxygen, and very particularly preferably is isopropylidene,
n is an average number of from 10 to 400, preferably 10 to 100, especially preferably 15 to 50 and
m is an average number of from 1 to 10, preferably from 1 to 6 and especially preferably from 1.5 to 5.

The siloxane block may likewise preferably be derived from the following structure

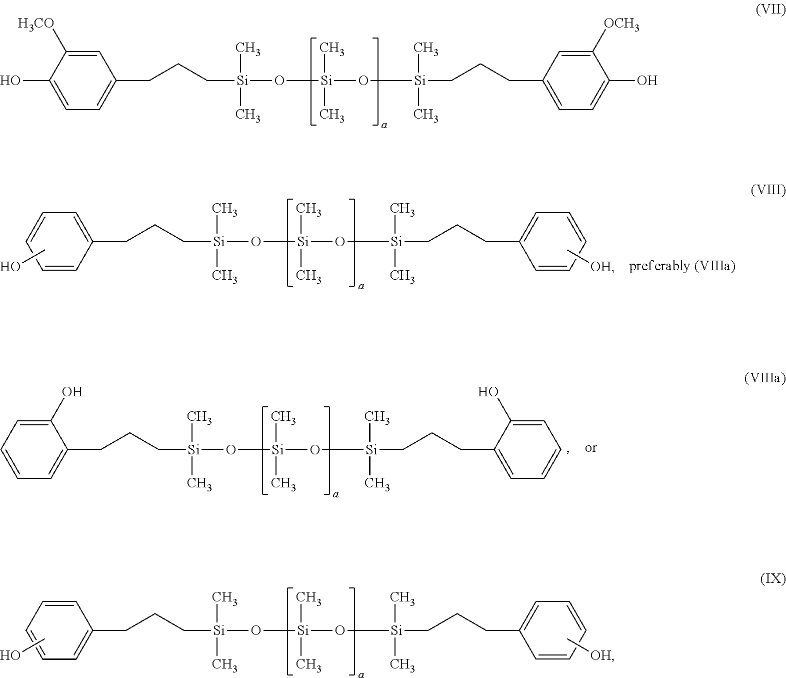

wherein a in formulae (VII), (VIII) and (IX) represents an average number from 10 to 400, preferably 10 to 100 and particularly preferably 15 to 50.

It is likewise preferable when at least two identical or different siloxane blocks of general formulae (VII), (VIII) or (IX) are joined to one another via terephthalic acid and/or isophthalic acid to form ester groups.

It is likewise preferable when in formula (1a) p=0, V is C₃-alkylene, r=1, Z is C₂-alkylene, R⁸ and R⁹ are methyl, q=1, W is C₃-alkylene, m=1, R⁸ is hydrogen or C₁- to C₄-alkyl, preferably hydrogen or methyl, R⁶ and R⁷ each independently of one another are C₁- to C₄-alkyl, preferably methyl, and o is 10 to 500.

Production of a hydroxyaryl-terminated polysiloxane according to any of formulae (1) to (3) is described for example in EP 0 122 535 A2, U.S. Pat. No. 2,013,026 7665 A1 or WO 2015/052229 A1.

The hydroxyaryl-terminated polysiloxane of formula (1), (2) or (3) or else (VII) or (VIII) is employed in amounts of 0.5% to 50% by weight, preferably of 1% to 40% by weight, especially preferably of 2% to 20% by weight and very particularly preferably of 2.5% to 10% by weight in each case based on the sum of the masses of the oligocarbonate and the hydroxyaryl-terminated polysiloxane.

The polysiloxane-polycarbonate block copolymers obtainable by the process according to the invention and the polymer compositions further produced therefrom may be processed into any desired shaped bodies in the manner known for thermoplastic polymers, in particular polycarbonates.

In this connection, the polysiloxane-polycarbonate block copolymers obtainable by the process according to the invention and the polymer compositions further produced therefrom may be converted into articles of manufacture, shaped bodies or shaped articles (shaped parts) for example by hot pressing, spinning, blow moulding, thermoforming, extruding or injection moulding. Use in multilayer systems is also of interest. Application of the composition obtainable according to the invention may be employed for example in multicomponent injection moulding or as a substrate for a coextrusion layer. However, application may also be to the ready-moulded main body, for example by lamination with a film or by coating with a solution.

Sheets or shaped bodies composed of a base layer and an optional outerlayer/optional outerlayers (multilayer systems) may be produced by (co)extrusion, direct skinning, direct coating, insert moulding, in-mould coating, or other suitable methods known to those skilled in the art.

The polysiloxane-polycarbonate block copolymers obtainable by the process according to the invention and the polymer compositions further produced therefrom, in particular polycarbonate compositions, are employable anywhere where known aromatic polycarbonates have hitherto been used and where good flowability coupled with improved mould release characteristics, high toughness at low temperatures and better chemicals resistance are additionally required, for example for production of large motor vehicle exterior parts and control boxes for exterior applications, of sheets, twin-wall sheets, of parts for electricals and electronics and of optical storage media. The polysiloxane-polycarbonate block copolymers may thus be employed in the IT sector for computer housings, multimedia housings and mobile phone housings, in the household sector such as in washing machines or dishwashers and in the sports sector, for example as a material for helmets.

### EXEMPLARY EMBODIMENTS

The present invention is illustrated by reference to working examples, without any intention to limit the invention to these examples. The determination methods described below are employed for all corresponding parameters in the present invention in the absence of any statement to the contrary.

### Relative Solution Viscosity

The relative solution viscosity (ηrel; also referred to as eta rel) was determined using an Ubbelohde viscometer in dichloromethane at a concentration of 5 g/l at 25° C.

### Evaluation of Polysiloxane Domain Size and Polysiloxane Domain Size Distribution by Atomic Force Microscopy (AFM)

The polysiloxane domain size and the size distribution of the polysiloxane domains were determined by atomic force microscopy. To this end, the respective sample (in the form of pellet material in extrusion batches) was cut under nitrogen cooling (−196° C.) using an ultramicrotome. A Bruker D3100 AFM microscope was used. The AFM image was recorded at room temperature (25° C., 30% relative humidity).

The “Soft Intermittent Contact Mode” or “Tapping Mode” were used for the measurement. A “tapping mode cantilever” (Nanoworld pointprobe) having a spring constant of about 2.8 Nm⁻¹ and a resonance frequency of about 75 kHz was used to scan the sample. The tapping force is controlled by the ratio of the target amplitude and the free oscillation amplitude (amplitude of the probe tip with free oscillation in air). The sampling rate was set to 1 Hz. To record the surface morphology, phase contrast and topography images were recorded on a 2.5 μm×2.5 μm area. The polysiloxane domains were evaluated automatically using Olympus SIS image processing software (Olympus Soft Imaging Solutions GmbH, 48149, Munster, Germany) via light-dark contrast from the phase contrast images. The diameters of the polysiloxane domains were determined via the diameter of the equivalent area of a circle of the cross section of the polysiloxane domain visible in the cut.

Each sample was subjected to four (4) scans over an area of 5×5 mm² and the phase-contrast images were evaluated by image analysis as described above. Assuming spherical objects, the volume of the cut polysiloxane domains was calculated and statistically evaluated. The image processing software was used to classify the individual diameters and capture a distribution of the diameters. This distribution was used to determine the volume fraction of the polysiloxane domains whose diameter is less than 100 nm and the volume fraction of the polysiloxane domains whose diameter is less than 200 nm and the volume fraction of the polysiloxane domains whose diameter is greater than 500 nm. The resolution limit was 20 nm.

### Starting Materials:

### Oligocarbonate (Component A)

The starting material used for producing a polysiloxane-polycarbonate block copolymer was linear bisphenol A oligocarbonate containing phenyl end groups and phenolic OH end groups having a relative solution viscosity of 1.17. This oligocarbonate did not contain any additives such as UV stabilizers, mould release agents or thermal stabilizers. Production of the oligocarbonate was carried out via a melt transesterification process as described for example in WO2019238419A1 and was withdrawn directly at the outlet of a high-viscosity reactor. The oligocarbonate has a phenolic end group content of 0.16% by weight.

The oligocarbonate was dried at 120° C. for at least 2 hours in an air circulation dryer before use.

### Hydroxyaryl-Terminated Polysiloxane Containing Compatibilizer (Component B1)

The hydroxyaryl-terminated polysiloxane employed was a bisphenol A-terminated polydimethylsiloxane of formula (3) where n is between 25 and 32 and m is in the range from 2.5 to 4 (R¹=H, R²=methyl; X=isopropylidene) having a hydroxy content between 14 and 20 mg KOH/g and a viscosity between 350 and 650 mPas (23° C.); the polysiloxane is admixed with sodium benzoate, the sodium content being between 0.8 and 1.3 ppm. Per 9 parts of the hydroxyaryl-terminated polysiloxane, 1 part of the siloxane Dow Corning® 40-001 (Dow Corning Corporation) is added as compatibilizer.

Hydroxyaryl-Terminated Polysiloxane without Compatibilizer (Component B2)

The hydroxyaryl-terminated polysiloxane employed was a bisphenol A-terminated polydimethylsiloxane of formula (3) where n is between 25 and 32 and m is in the range from 2.5 to 4 (R¹═H, R²=methyl; X=isopropylidene) having a hydroxy content between 14 and 20 mg KOH/g and a viscosity between 350 and 650 mPas (23° C.); the polysiloxane is admixed with sodium benzoate, the sodium content being between 0.8 and 1.3 ppm.

### Experimental Setup for Example 7 and Example 8 (Inventive)

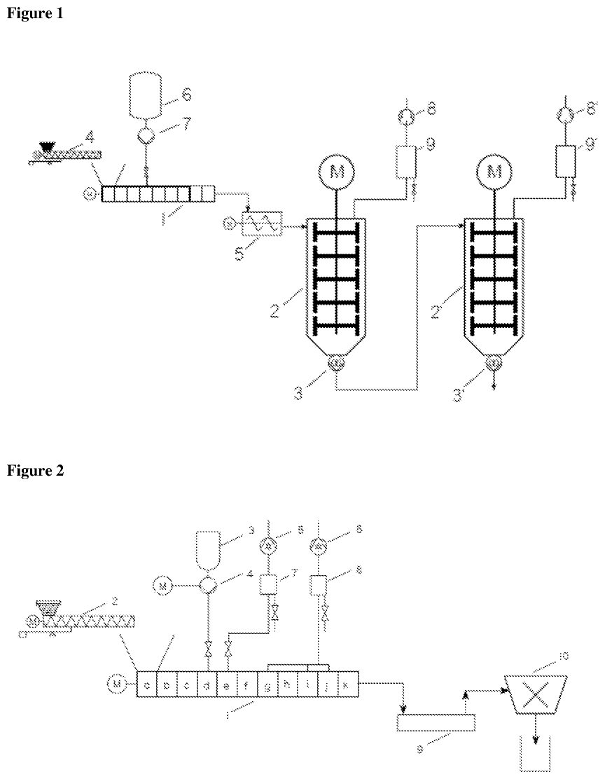

FIG. 1 shows the experimental setup for the experiments relating to one of the embodiments of the process according to the invention, steps (1) to (4) of the process according to the invention in that embodiment, in which precisely two thin-film evaporators are used for producing polysiloxane-polycarbonate block copolymer by polycondensation. An oligocarbonate (component A) in the form of pellet material was introduced to a plasticizing extruder (1) using a gravimetric metering balance (4) and melted. A hydroxyaryl-terminated polysiloxane (component B2) was provided in a reservoir container (6) in liquid form and continuously metered into the plasticizing extruder (1) via a pump (7). The metering of the hydroxyaryl-terminated polysiloxane into the plasticizing extruder (1) was effected in the melt of the oligocarbonate, i.e. downstream of the plasticizing zone of the extruder (1). The plasticizing extruder performed a premixing of the components A and B. The mixture was passed to an INDAG DLS/M 007 dynamic mixer (5). The mixer was operated at 500 rpm. The obtained reaction mixture was subsequently passed to a first thin-film evaporator (2). The first thin-film evaporator (2) was evacuated using a vacuum pump (9). The offgas was passed through a condenser (8), where the condensable constituents, in particular phenol, were separated. After discharging from the first thin-film evaporator (2), the obtained reaction mixture containing an intermediate polysiloxane-polycarbonate block copolymer and unconverted oligocarbonate and unconverted hydroxyaryl-terminated polysiloxane was passed to a second thin-film evaporator (2′) via a melt conduit by means of a gear pump (3). After the second thin-film evaporator (2′), the obtained polysiloxane-polycarbonate block copolymer was spun through a die plate (not shown) using a gear pump (3′) and pelletized. The second thin-film evaporator (2′) was also evacuated via a vacuum pump (9′) and condensable constituents of the offgas, in particular phenol, were separated in a condenser (8′).

The two thin-film evaporators (2) and (2′) each had a heat transfer area of 0.5 m². The heat transfer areas of the two thin-film evaporators (2) and (2′) were each passed over by a vertical rotor having wiper blade elements at the circumference.

Experimental Setup with Twin-Screw Extruder

### (For Production of the Intermediate Polysiloxane-Polycarbonate Block Copolymer Used in the Comparative Examples 1 and 2 and in the Inventive Examples 5 and 6)

The scheme of the experimental setup with a twin-screw extruder is apparent from FIG. 2.

FIG. 2 shows a scheme for producing a polysiloxane-polycarbonate block copolymer. An oligocarbonate (component A) was metered into a twin-screw extruder (1) via a gravimetric feeder (2). The extruder (ZSE 27 MAXX from Leistritz Extrusionstechnik GmbH, Nuremberg) was a co-rotating twin-screw extruder with vacuum zones for removal of the vapours. The twin-screw extruder (1) consisted of 11 housing sections (a to k). Addition of the oligocarbonate (component A) was carried out in housing section a via the differential metering balance (2) and the melting of the oligocarbonate was carried out in housings b and c. housing sections d and e were also used for incorporating the liquid hydroxyaryl-terminated polysiloxane containing a compatibilizer (component B1), housing sections e, g, i and j were provided with degassing openings to remove the condensation products, in particular phenol. housing section e was assigned to the first vacuum stage and housing sections g, i and j were assigned to the second vacuum stage. The pressure in the first vacuum stage was between 45 and 65 mbara unless otherwise stated. The pressure in the second vacuum stage was less than 1 mbara. The hydroxyaryl-terminated polysiloxane containing a compatibilizer (component B1) was initially charged in a tank (3) and introduced into the twin-screw extruder (1) via a metering pump (4). The negative pressure was generated via vacuum pumps (5) and (6). The vapours were conducted away from the twin-screw extruder (1) and passed through 2 condensers (7) and (8) where the condensation products, in particular phenol, were condensed. The melt of the polysiloxane-polycarbonate block copolymer was formed into a strand, passed into a water bath (9) and comminuted by the pelletizer (10).

Experimental Setup with High-Viscosity Reactor

### (For Comparative Examples 3 and 4)

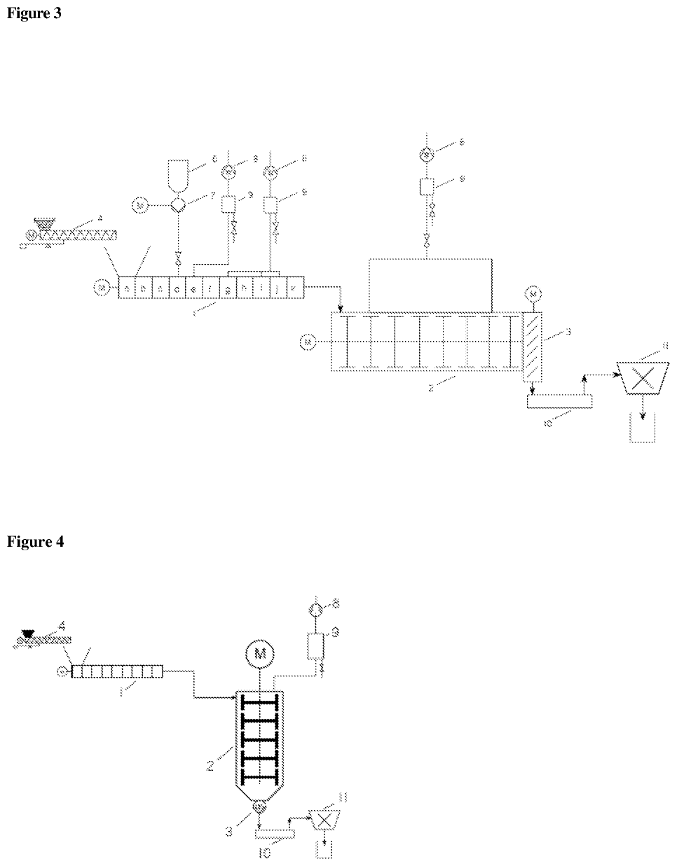

The scheme of the experimental setup with a high-viscosity reactor is apparent from FIG. 3.

FIG. 3 shows a scheme for producing a polysiloxane-polycarbonate block copolymer. An oligocarbonate (component A) was metered into a twin-screw extruder (1) via a gravimetric supply means (4). The twin-screw extruder (1) (ZSE 27 MAXX from Leistritz Extrusionstechnik GmbH, Nuremberg) is a co-rotating twin-screw extruder with vacuum zones for removal of the vapours. The twin-screw extruder (1) consisted of 11 housing sections (a to k). Addition of oligocarbonate was carried out in housing section a and the melting of this oligocarbonate was carried out in housing sections b and c. Addition of a liquid hydroxyaryl-terminated polysiloxane containing a compatibilizer (component B1) was carried out in housing section d. housing sections e and f were used for incorporation of the liquid hydroxyaryl-terminated polysiloxane. housing sections g, h, i and j were provided with degassing openings to remove the condensation products. housing sections g and h were assigned to the first vacuum stage and housing sections i and j were assigned to the second vacuum stage. The pressure in the first vacuum stage was between 250 and 500 mbara unless otherwise stated. The pressure in the second vacuum stage was less than 1 mbara. The hydroxyaryl-terminated polysiloxane was initially charged in a tank (6) and introduced into the twin-screw extruder (1) via a metering pump (7). The negative pressure was generated via 2 vacuum pumps (8). The vapours were conducted away from twin-screw extruder (1) and collected in 2 condensers (9). The thus-degassed and partially condensed melt was passed via a conduit from housing section k of the twin-screw extruder (1) to a high-viscosity reactor (2).

The high-viscosity reactor (2) was a self-cleaning apparatus having two counter-rotating rotors arranged horizontally and axially parallel. The construction is described in European patent application EP0460466A1; see FIG. 7 therein. The employed high-viscosity reactor (2) had a housing diameter of 187 mm at a length of 924 mm. The interior of the high-viscosity reactor (2) fillable by the reaction mixture had a volume of 44.6 litres. The high-viscosity reactor was likewise connected to a vacuum pump (8) and to a condenser (9). The pressure at the high-viscosity reactor (2) was 0.1 to 5 mbara. After completion of the reaction, the obtained polysiloxane-polycarbonate block copolymer was discharged via a discharge screw (3) and subsequently pelletized (via a water bath (10) and a pelletizer (11)).

### Comparative Example 1: Experiment with Rotating-Disc Reactor

The experimental setup according to FIG. 2 was initially used to produce an intermediate polysiloxane-polycarbonate block copolymer. To this end, 9.5 kg/h of an oligocarbonate (component A) having a relative solution viscosity of 1.17 were metered into the housing (a) of the twin-screw extruder (1) (see FIG. 2). The hydroxyaryl-terminated polysiloxane containing a compatibilizer (component B1) was introduced into the housing (d) of the twin-screw extruder (1) at 0.475 kg/h. The twin-screw extruder (1) was operated at a speed of 400 rpm. This resulted in a shear rate of 5970 l/s between the screw chambers of the screw elements of the twin-screw extruder (1) and the housing wall of the twin-screw extruder (1).

The extruder housings were heated according to the following scheme: housing (a) unheated, housing (b) 170° C., housings (c) and (d) 240° C., housing (e) 250° C., housing (f) 260° C., housings (g) and (h) 270° C., housing (i) 275° C., housing (j) 285° C. and housing (k) 295° C. A pressure of 40 mbara was applied to housing (e). A pressure of 0.6 mbara was applied to the housings (g), (i) and (j). The intermediate polysiloxane-polycarbonate block copolymer was extruded at a melt temperature of 323° C., passed through the water bath (10) and pelletized.

10 kg of the intermediate polysiloxane-polycarbonate block copolymer thus produced were melted in a rotating-disc reactor from Uhde Inventa Fischer GmbH having 2 discs, each of 800 mm in diameter. The melt was polycondensed in the rotating-disc reactor at 300° C. and 1 mbara for 87 minutes at a rotor speed of 2.5 rpm. Phenol was continuously removed. The obtained polysiloxane-polycarbonate block copolymer was discharged and pelletized. The thus-obtained polysiloxane-polycarbonate block copolymer has a relative solution viscosity of eta rel 1.26. The discs of the reactor are wiped with wipers, resulting in a shear rate of 10 l/s. The shear rate in the falling film at the discs is less than 10 l/s.

### Comparative Example 2

10 kg of an intermediate polysiloxane-polycarbonate block copolymer (FIG. 2) produced using the twin-screw extruder as in comparative example 1 were melted in the rotating-disc reactor from comparative example 1. The intermediate polysiloxane-polycarbonate block copolymer was polycondensed in the rotating-disc reactor at 300° C. and 1 mbar for 110 minutes at a speed of 2.5 rpm. The discs of the reactor are wiped with wipers, resulting in a shear rate of 10 l/s. The shear rate in the falling film at the discs is less than 10 l/s. Phenol was continuously removed. The obtained polysiloxane-polycarbonate block copolymer was discharged and pelletized. The thus-obtained polysiloxane-polycarbonate block copolymer has a relative solution viscosity of eta rel 1.33.

The size distribution of the polysiloxane domains in the polysiloxane-polycarbonate block copolymers from comparative example 1 and from comparative example 2 were determined by AFM as described above. It was found that in the polysiloxane-polycarbonate block copolymer from comparative example 1, 73% by volume of the polysiloxane visible in the AFM images is present in polysiloxane domains larger than 500 nm, and only a volume fraction of 7.9% by volume of the polysiloxane is present in domains smaller than 200 nm. In the polysiloxane-polycarbonate block copolymer from comparative example 2, 34% by volume of the polysiloxane visible in the AFM images is present in polysiloxane domains larger than 500 nm and only 20% by volume of the polysiloxane is present in domains smaller than 200 nm. Experience has shown that especially polysiloxane domains larger than 500 nm result in severe surface defects in injection moulded components. Even polysiloxane domains larger than 200 nm can result in deterioration of the aesthetic appearance of injection moulded components. The products from comparative examples 1 and 2 thus fail to meet the requirement of a fine polysiloxane domain size distribution.

### Comparative Example 3

Experiment with High-Viscosity Reactor

With the experimental setup according to FIG. 3, 28.6 kg/h of oligocarbonate (component A) and 1.43 kg/h of a hydroxyaryl-terminated polysiloxane containing a compatibilizer (component B1) were measured into the twin-screw extruder (1). The speed of the twin-screw extruder (1) was 850 rpm. This resulted in a shear rate of 12 700 l/s between the screw chambers of the screw elements of the twin-screw extruder (1) and the housing wall of the twin-screw extruder (1). The extruder housings were heated according to the following scheme: housing (a) unheated, housing (b) 170° C., housings (c) and (d) 240° C., housing (e) 250° C., housing (f) 260° C., housings (g) and (h) 270° C., housing (i) 275° C., housing (j) 285° C. and housing (k) 295° C. A pressure of 140 mbara was applied to housing (e) and a pressure of 0.8 mbara was applied to each of housings (g), (i) and (j). The outlet temperature from the twin-screw extruder (1) was 308° C. The extruded polymer melt was transferred to the high-viscosity reactor (2) via a pipe conduit. The speed of the high-viscosity reactor was 30 rpm. This resulted in a shear rate between the rotors of the high-viscosity reactor (2) and the housing inner wall of the high-viscosity reactor (2) of 114 l/s. The housing temperature of the high-viscosity reactor (2) was 330° C. The pressure in the interior of the high-viscosity reactor (2) was 0.5 mbara. A light-coloured polysiloxane-polycarbonate block copolymer having a relative solution viscosity of 1.376 was obtained.

### Comparative Example 4

Experiment with High-Viscosity Reactor

With the experimental setup according to FIG. 3, 23.8 kg/h of oligocarbonate (component A) and 1.19 kg/h of a hydroxyaryl-terminated polysiloxane containing a compatibilizer (component B1) were measured into the twin-screw extruder (1). The speed of the extruder was 700 rpm. This resulted in a shear rate of 10 450 l/s between the screw chambers of the screw elements of the twin-screw extruder (1) and the housing wall of the twin-screw extruder (1). The extruder housings of the twin-screw extruder (1) were heated according to the following scheme: housing (a) unheated, housing (b) 170° C., housings (c) and (d) 240° C., housing (e) 250° C., housing (f) 260° C., housings (g) and (h) 270° C., housing (i) 275° C., housing (j) 285° C. and housing (k) 295° C. Housing (e) and each of housings (g), (i) and (j) were at standard pressure. The melt was transferred to the high-viscosity reactor (2). The speed was 45 rpm. This resulted in a shear rate between the rotors of the high-viscosity reactor (2) and the housing inner wall of the high-viscosity reactor (2) of 172 l/s. The housing temperature of the high-viscosity reactor (2) was 310° C. The pressure applied at the housing of the high-viscosity reactor (2) was 1.6 mbara. A light-coloured polysiloxane-polycarbonate block copolymer having a relative solution viscosity of 1.31 was obtained.

### Polysiloxane Domain Size Distribution by AFM of Comparative Example 3 and 4

The size of the polysiloxane domains in the products from comparative examples 3 and 4 was determined with the same method as also used in comparative examples 1 and 2. These products contain no polysiloxane domains larger than 500 nm. For the product from comparative example 3, 89.2% by volume of the employed polysiloxane is present in domains smaller than 100 nm and 100% by volume of the employed polysiloxane is present in domains smaller than 200 nm. The product from comparative example 3 thus does have a fine polysiloxane domain size distribution but this distribution was achievable only in conjunction with a very high relative solution viscosity which is outside the desired range. A material having such a high relative solution viscosity is processable in an injection moulding process only with added cost and complexity. Comparative example 4 shows that it is possible in principle to adapt the production process such that the relative solution viscosity is in the desired range. However, a fine polysiloxane domain size distribution is then no longer obtained. In the product from comparative example 4, 74.8% by volume of the employed polysiloxane is present in domains larger than 100 nm and 38.4% by volume of the employed polysiloxane is present in domains larger than 200 nm.

### Example 5

(Inventive; with Precisely One Thin-Film Evaporator According to FIG. 4)

In the experimental setup according to FIG. 2, initially 21 kg/h of an oligocarbonate (component A) having a relative viscosity of 1.17 are metered into the housing (a) of the twin-screw extruder (1) and the hydroxyaryl-terminated polysiloxane containing a compatibilizer (component B1) was introduced into the housing (d) of the twin-screw extruder (1) at 1.05 kg/h. The twin-screw extruder (1) was operated at a speed of 500 rpm. This resulted in a shear rate of 7560 l/s between the screw chambers of the screw elements of the twin-screw extruder (1) and the housing wall of the twin-screw extruder (1). The extruder housing of the twin-screw extruder (1) was heated according to the following scheme: housing (a) unheated, housing (b) 170° C., housings (c) and (d) 240° C., housing (e) 250° C., housings (f) to (k) 260° C. No negative pressure is applied. Since the lack of negative pressure means that any reaction products formed, such as for example phenol, are discharged only to a very small extent, if at all, it is essentially a physical mixture (blend) of an oligocarbonate and a polysiloxane without a reactive bond that is formed.

The blend of an oligocarbonate and a polysiloxane formed in this way is melted in a plasticizing extruder (1) and conveyed to a thin-film evaporator (2) according to FIG. 4 using a gear pump (not shown). The blend is introduced into the thin-film evaporator (2) at a melt temperature of about 265° C. and a throughput of 20 kg/h and condensed at a housing temperature of 334° C. The pressure in the thin-film evaporator (2) was 0.4 mbara. The shear rate between the outer edges of the wiper blade elements and the inner surface area of the reaction chamber of the thin-film evaporator (2) was 3930 l/s. A light-coloured pellet material having a relative solution viscosity of 1.30 was obtained.

The thin-film evaporator (2) had a heat transfer area of 0.5 m². The heat transfer area of the thin-film evaporator (2) was wiped by a vertical rotor having four wiper blade elements at the circumference at a speed of 500 rpm; this results in a frequency of surface renewal of 33.3 Hz.

### Example 6

(Inventive; with Precisely One Thin-Film Evaporator According to FIG. 4)

Just as described in example 5, a blend of an oligocarbonate (component A) and a hydroxyaryl-terminated polysiloxane containing a compatibilizer (component B1) was initially produced. This is melted in a plasticizing extruder (1) and conveyed using a gear pump (not shown) to a thin-film evaporator (2) according to FIG. 4. The blend is introduced into the thin-film evaporator (2) at a melt temperature of about 265° C. and a throughput of 18 kg/h and condensed at a housing temperature of 334° C. The pressure in the thin-film evaporator (2) was 0.4 mbar. The shear rate between the outer edges of the wiper blade elements and the inner surface area of the reaction chamber of the thin-film evaporator (2) was 3530 l/s. The thin-film evaporator (2) had a heat transfer area of 0.5 m². The heat transfer area of the thin-film evaporator (2) was wiped by a vertical rotor having four wiper blade elements at the circumference at a speed of 450 rpm; this results in a frequency of surface renewal of 30 Hz.

A light-coloured pellet material having a relative solution viscosity of 1.285 was obtained.

### Example 7—Inventive with Precisely Two Thin-Film Evaporators According to FIG. 1

36.9 kg/h of oligocarbonate (component A) was plasticized on a plasticizing extruder (1) and 2 kg/h of hydroxyaryl-terminated polysiloxane without compatibilizer (component B2) were incorporated into the melt in the plasticizing extruder (1) to produce a premixture. For further homogenization, the premixture of oligocarbonate and hydroxyaryl-terminated polysiloxane without compatibilizer was passed through a DLM/S 007 dynamic mixer (5) from INDAG Maschinenbau which was operated at a speed of 500 rpm. At a temperature of 284° C., the premixture subsequently entered a first thin-film evaporator (2) having a heat transfer area of 0.5 m² which was operated with a shear rate of 3110 l/s between the outer edges of the wiper blade elements and the inner surface of the reaction chamber, a housing temperature of 310° C. in its upper half and of 300° C. in its lower half, and a pressure of 1 mbara. The obtained melt was discharged and using a gear pump (3) conveyed to the second thin-film evaporator (2′) having a heat transfer area of 0.5 m².

The second thin-film evaporator (2′) was operated with a shear rate of 860 l/s between the outer edges of the wiper blade elements and the inner surface area of the reaction chamber and at a pressure of 1 mbara. The upper half of the reaction chamber of the thin-film evaporator (2′) was heated to 320° C. and the lower half to 317° C. The melt was thus further condensed and was discharged via the gear pump (3′) at 361° C. The heat transfer area of the thin-film evaporator (2) was wiped by a vertical rotor having four wiper blade elements at the circumference at a speed of 330 rpm; this results in a frequency of surface renewal of 22 Hz. The heat transfer area of the thin-film evaporator (2′) was wiped by a vertical rotor having four wiper blade elements at the circumference at a speed of 220 rpm; this results in a frequency of surface renewal of 14.7 Hz.

A light-coloured polysiloxane-polycarbonate block copolymer having a relative solution viscosity of 1.324 was obtained.

### Example 8

(Inventive with Precisely Two Thin-Film Evaporators According to FIG. 1)

41 kg/h of oligocarbonate (component A) were plasticized on a plasticizing extruder (1) and 2.32 kg/h of hydroxyaryl-terminated polysiloxane without compatibilizer (component B2) having an OH number of 19.2 mg KOH/g were incorporated into the melt in the plasticizing extruder (1) to produce a premixture. For further homogenization, the premixture of oligocarbonate and hydroxyaryl-terminated polysiloxane without compatibilizer was passed through a DLM/S 007 dynamic mixer (5) from INDAG Maschinenbau which was operated at a speed of 500 rpm. At a temperature of 275° C., the premixture subsequently entered a first thin-film evaporator (2) having a heat transfer area of 0.5 m² which was operated with a shear rate of 710 l/s between the outer edges of the wiper blade elements and the inner surface area of the reaction chamber, a housing temperature of uniformly 290° C. and a pressure of 1 mbara. The obtained melt was discharged and using a gear pump (3) conveyed to the second thin-film evaporator (2′) having a heat transfer area of 0.5 m².

The second thin-film evaporator (2′) was operated with a shear rate of 635 l/s between the outer edges of the wiper elements and the inner surface area of the reaction chamber and at a pressure of 1 mbara. The upper half of the thin-film evaporator (2′) was heated uniformly to 310° C. The melt was thus further condensed and discharged via the gear pump (3′) at 329° C. The heat transfer area of the thin-film evaporator (2) was wiped by a vertical rotor having four wiper blade elements at the circumference at a speed of 189 rpm; this results in a frequency of surface renewal of 12.6 Hz. The heat transfer area of the thin-film evaporator (2′) was wiped by a vertical rotor having four wiper blade elements at the circumference at a speed of 202 rpm; this results in a frequency of surface renewal of 13.5 Hz.

A light-coloured polysiloxane-polycarbonate block copolymer having a relative solution viscosity of 1.315 was obtained.

Comparative example 1 shows that a process using a rotating-disc reactor makes it possible to produce polysiloxane-polycarbonate block copolymers. The relative solution viscosity of the material from comparative example 1 of eta rel 1.26 is in a range which exhibits satisfactory flowability. However, the polysiloxane-polycarbonate block copolymer comprises polysiloxane domains having diameters above 500 nm. The volume fraction of polysiloxane domains having diameters above 500 nm is very high at 73% by volume. An injection-moulded article produced from a polysiloxane-polycarbonate block copolymer having this size distribution of the polysiloxane domains is unusable for many commercial applications.

Comparative example 2 shows that the polysiloxane domain distribution can be made finer through longer residence times. The volume fraction of polysiloxane domains having diameters above 500 nm falls markedly. However, the relative solution viscosity also increases significantly and so the polysiloxane-polycarbonate block copolymer no longer exhibits acceptable flowability. Since the size distribution of the polysiloxane domains becomes finer with increasing relative solution viscosity, it is surprising that despite the markedly poorer flowability with a relative solution viscosity of 1.33 more than a third of the volume of the polysiloxane is still found in domains having diameters above 500 nm. Accordingly, an injection-moulded article produced from this polysiloxane-polycarbonate block copolymer is also not usable for many commercial applications.

A process using a rotating-disc reactor thus does not achieve the object of the present invention.

Comparative examples 3 and 4 were performed using a high-viscosity reactor. Comparative example 3 shows that fine polysiloxane domain size distributions are also achievable with a high-viscosity reactor. However, the viscosity, with a relative solution viscosity of 1.376, is high and flowability is thus unsatisfactory. By contrast, comparative example 4, while exhibiting a useful flowability, has a poor size distribution of the polysiloxane domains.

Thus a process using a high-viscosity reactor also fails to achieve the object of the present invention.

Inventive examples 5 and 6 show that a process using precisely one thin-film evaporator and employing high shear rates, low pressures and high rates of surface renewal at moderate temperatures makes it possible to produce a polysiloxane-polycarbonate block copolymer which exhibits both a fine polysiloxane domain size distribution and a flowability useful for processing in injection moulding. The recited process for producing a polysiloxane-polycarbonate block copolymer using precisely one thin-film evaporator thus achieves the object of the present invention.

Inventive examples 7 and 8 show that a process using a cascade of two thin-film evaporators and employing high shear rates, low pressures and high rates of surface renewal at moderate temperatures makes it possible to produce a polysiloxane-polycarbonate block copolymer which exhibits both a fine polysiloxane domain size distribution and a flowability useful for processing in injection moulding. The recited process for producing a polysiloxane-polycarbonate block copolymer using precisely two thin-film evaporators thus achieves the object of the present invention. This configuration of the process according to the invention is particularly advantageous because the object is achieved without addition of a compatibilizer.

For the sake of simplicity, table 1 reproduces the values for the volume fractions of the polysiloxane domains for various diameters of the accompanying polysiloxane domains obtained in the individual experiments and the accompanying relative solution viscosities.

TABLE 1

| | | Vol. fraction | Vol. fraction | Vol. fraction | Relative |
|---|---|---|---|---|---|
| | | Particles <100 | Particles <200 | Particles >500 | solution |
| | | nm [% by | nm [% by | nm [% by | viscosity |
| No. | | vol.] | vol.] | vol.] | (eta rel). |
| 1 | Comparative | 3.3 | 7.9 | 73.1 | 1.26 |
| | example | | | | |
| 2 | Comparative | 11.4 | 20.1 | 33.6 | 1.33 |
| | example | | | | |
| 3 | Comparative | 89.2 | 100 | 0 | 1.376 |
| | example | | | | |
| 4 | Comparative | 25.2 | 61.6 | 0 | 1.31 |
| | example | | | | |
| 5 | Inventive | 74.3 | 100 | 0 | 1.30 |
| 6 | Inventive | 57.5 | 91.7 | 0 | 1.285 |
| 7 | Inventive | 77.0 | 100 | 0 | 1.324 |
| 8 | Inventive | 70.2% | 100 | 0 | 1.315 |

1. A process for continuous production of a polysiloxane-polycarbonate block copolymer using precisely one thin-film evaporator,
wherein the process comprises the following process steps:
(1) providing a reaction mixture containing an oligocarbonate having a relative solution viscosity of 1.08 to 1.22 and having an OH group content of 1000 to 2500 ppm and containing a hydroxyaryl-terminated polysiloxane,
(2) introducing the reaction mixture provided in step (1) containing an oligocarbonate and a hydroxyaryl-terminated polysiloxane into the precisely one thin-film evaporator, wherein the thin-film evaporator comprises precisely one reaction chamber with precisely one rotor having at least two wiper blade elements at the circumference, wherein the precisely one rotor rotates in the thin-film evaporator and wherein each wiper blade element has one outer edge,
(3) reacting the reaction mixture from step (2) to afford a polysiloxane-polycarbonate block copolymer, wherein the reaction mixture is conveyed from an intake of the thin-film evaporator to the outlet of the thin-film evaporator,
(4) discharging the polysiloxane-polycarbonate block copolymer obtained in step (3) from the thin-film evaporator,
wherein in step (3), in the precisely one thin-film evaporator, the following process conditions are observed:
(3.a) shear rate between the outer edge of the at least two rotating wiper blade elements at the circumference and the axially extending rotationally symmetrical inner surface area of the reaction chamber of the thin-film evaporator of 500 l/s to 5000 l/s,
(3.b) pressure in the reaction chamber of the thin-film evaporator of 0.01 mbara to 10 mbara,
(3.c) temperature of the reaction mixture in the reaction chamber of 280° C. to 370° C.,
(3.d) frequency of surface renewal of the reaction mixture of 10 to 50 Hz.

2. A process for continuous production of a polysiloxane-polycarbonate block copolymer using a number of serially arranged thin-film evaporators, wherein the number is at least two,
wherein the process comprises the following process steps:
(1) providing a reaction mixture containing an oligocarbonate having a relative solution viscosity of 1.08 to 1.22 and having an OH group content of 1000 to 2500 ppm and containing a hydroxyaryl-terminated polysiloxane,
(2) introducing the reaction mixture provided in step (1) containing an oligocarbonate and a hydroxyaryl-terminated polysiloxane into the first of the at least two serially arranged thin-film evaporators,
wherein each of the at least two thin-film evaporators comprises precisely one reaction chamber having precisely one rotor, each rotor having at least two wiper blade elements at the circumference, wherein the precisely one rotor in each thin-film evaporator rotates and wherein each wiper blade element has one outer edge,
(3) reacting the reaction mixture from step (2) to afford a polysiloxane-polycarbonate block copolymer,
wherein the reaction mixture is conveyed from an intake of the first thin-film evaporator of the at least two serially arranged thin-film evaporators to an outlet of the last thin-film evaporator of the at least two serially arranged thin-film evaporators,
(4) discharging the polysiloxane-polycarbonate block copolymer obtained in step (3) from the last thin-film evaporator,
wherein in step (3), in the last of the at least two serially arranged thin-film evaporators, the following process conditions are observed:
(3.a) shear rate between the outer edge of the at least two rotating wiper blade elements at the circumference and the axially extending rotationally symmetrical inner surface area of the reaction chamber of the thin-film evaporator of 500 l/s to 5000 l/s,
(3.b) pressure in the reaction chamber of the thin-film evaporator of 0.01 mbara to 10 mbara,
(3.c) temperature of the reaction mixture in the reaction chamber of 280° C. to 370° C.,
(3.d) frequency of surface renewal of the reaction mixture of 10 to 50 Hz.

3. The process according to claim 1, wherein in process step (3) in the single thin-film evaporator the following process condition is observed:
(3.a.a) that the shear rate between the rotating outer edge of a wiper blade element and the axially extending rotationally symmetric inner surface area of the reaction chamber of the thin-film evaporator is from 500 l/s to 4000 l/s.

4. The process according to claim 1, wherein in process step (3) in the single thin-film evaporator the following process condition is observed:
(3.b.a) that the pressure in the reaction chamber of the thin-film evaporator is from 0.1 mbara to 6 mbara.

5. The process according to claim 1, wherein the relative solution viscosity of the oligocarbonate provided in step (1) is from 1.11 to 1.22.

6. The process according to claim 1, wherein the polysiloxane content of the polysiloxane-polycarbonate block copolymer is from 2% to 15% by weight, wherein the polysiloxane content is based on the total weight of the polysiloxane-polycarbonate block copolymer.

7. The process according to claim 6, wherein the polysiloxane content of the polysiloxane-polycarbonate block copolymer is from 3% to 10% by weight, wherein the polysiloxane content is based on the total weight of the polysiloxane-polycarbonate block copolymer.

8. The process according to claim 7, wherein the polysiloxane content of the polysiloxane-polycarbonate block copolymer is from 4% to 8% by weight, wherein the polysiloxane content is based on the total weight of the polysiloxane-polycarbonate block copolymer.

9. The process according to claim 7, wherein the polysiloxane content of the polysiloxane-polycarbonate block copolymer is from 4.5% to 5.5% by weight, wherein the polysiloxane content is based on the total weight of the polysiloxane-polycarbonate block copolymer.

10. The process according to claim 1, wherein the OH group content of the oligocarbonate provided in step (1) is from 1200 to 2300 ppm.

11. The process according to claim 1, wherein in step (1) the reaction mixture containing an oligocarbonate having a relative solution viscosity of 1.08 to 1.22, and having an OH group content of 1000 to 2500 ppm, and containing a hydroxyaryl-terminated polysiloxane is produced using dynamic and/or static mixers.

12. The process according to claim 2, wherein in step (3) of the process the following process conditions are observed:
in the first thin-film evaporator:
(3.1.a) shear rate between the outer edge of a rotating wiper blade element and the axially extending rotationally symmetrical inner surface area of the reaction chamber of the thin-film evaporator of 500 l/s to 5000 l/s,
(3.1.b) pressure in the reaction chamber of 1 mbara to 10 mbara,
(3.1.c) temperature of the reaction mixture in the reaction chamber of 270° C. to 350° C.,
(3.1.d) frequency of surface renewal of the reaction mixture of 10 to 30 Hz, and in the last thin-film evaporator:
(3.2.a) shear rate between the outer edge of the at least two rotating wiper blade elements and the axially extending rotationally symmetrical inner surface area of the reaction chamber of the thin-film evaporator of 500 l/s to 4000 l/s,
(3.2.b) pressure in the reaction chamber of 0.1 mbara to 3 mbara,
(3.2.c) temperature of the reaction mixture in the reaction chamber of 280° C. to 370° C.,
(3.2.d) frequency of surface renewal of the reaction mixture of 10 to 30 Hz.

13. A polysiloxane-polycarbonate block copolymer comprising the following features:
Polysiloxane content of 2% to 15% by weight based on the total weight of polysiloxane-polycarbonate block copolymer,
volume fraction of polysiloxane domains in the polysiloxane-polycarbonate block copolymer—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds a length of 500 nm is less than 0.1%; wherein the relative solution viscosity is from 1.38 to 1.24.

14. The polysiloxane-polycarbonate block copolymer according to claim 13 comprising the following features:
polysiloxane content of 4.5% to 5.5% by weight based on the total weight of the polysiloxane-polycarbonate block copolymer,
volume fraction of polysiloxane domains in the polysiloxane-polycarbonate block copolymer—measured based on the total volume of the polysiloxane domains—whose diameter exceeds 100 nm is less than 70%, wherein simultaneously the volume fraction of polysiloxane domains whose diameter exceeds 200 nm is less than 30%, wherein simultaneously the volume fraction of polysiloxane domains whose diameter exceeds a length of 500 nm is less than 0.1%; wherein the relative solution viscosity is from 1.24 to 1.34.

15. A method for producing shaped bodies comprising providing a polysiloxane-polycarbonate block copolymer according to claim 13.

16. The process according to claim 2, wherein in process step (3) in the last thin-film evaporator of a number of serially arranged thin-film evaporators the following process condition is observed:
(3.a.a) that the shear rate between the rotating outer edge of a wiper blade element and the axially extending rotationally symmetric inner surface area of the reaction chamber of the thin-film evaporator is from 500 l/s to 4000 l/s.

17. The process according to claim 2, wherein in process step (3) in the last thin-film evaporator of a number of serially arranged thin-film evaporators the following process condition is observed:
(3.b.a) that the pressure in the reaction chamber of the thin-film evaporator is from 0.1 mbara to 6 mbara.
